(19) United States
(12) Patent Application Publication
(10) Pub. No.: US 2026/0149503 A1
(43) Pub. Date: May 28, 2026

(54) OPTICAL LINKS WITH OXIDE-FREE QUANTUM DOT VCSELS ON A DIRECTLY MODULATED PHOTONIC WAFER-SCALE INTERPOSER

(71) Applicant: Volantis Semiconductor, Inc., Portland, OR (US)

(72) Inventors: Tapabrata Ghosh, San Francisco, CA (US); John Sonkoly, Boise, ID (US)

(73) Assignee: Volantis Semiconductor, Inc., Portland, OR (US)

(21) Appl. No.: 19/291,714

(22) Filed: Aug. 6, 2025

Related U.S. Application Data
(63) Continuation of application No. 19/290,530, filed on Aug. 5, 2025.
Application No. 19/290,530 is a continuation-in-part of application No. 19/289,269, filed on Aug. 4, 2025.
Application No. 19/289,269 is a continuation-in-part of application No. 19/260,549, filed on Jul. 6, 2025.
Application No. 19/260,549 is a continuation-in-part of application No. 19/260,471, filed on Jul. 5, 2025.
Application No. 19/260,471 is a continuation-in-part of application No. 19/243,462, filed on Jun. 19, 2025.
Application No. 19/243,462 is a continuation-in-part of application No. 19/235,870, filed on Jun. 12, 2025.
Application No. 19/235,870 is a continuation-in-part of application No. 19/230,233, filed on Jun. 6, 2025.
Application No. 19/230,233 is a continuation-in-part of application No. 19/223,614, filed on May 30, 2025.
Application No. 19/223,614 is a continuation-in-part of application No. 19/222,606, filed on May 29, 2025.
Application No. 19/222,606 is a continuation-in-part of application No. 19/211,446, filed on May 19, 2025.
Application No. 19/211,446 is a continuation-in-part of application No. 19/210,116, filed on May 16, 2025.
Application No. 19/210,116 is a continuation-in-part of application No. 19/192,587, filed on Apr. 29, 2025.
Application No. 19/192,587 is a continuation-in-part of application No. 19/192,146, filed on Apr. 28, 2025.
Application No. 19/192,146 is a continuation-in-part of application No. 19/189,471, filed on Apr. 25, 2025.
Application No. 19/189,471 is a continuation-in-part of application No. 19/188,057, filed on Apr. 24, 2025.
Application No. 19/188,057 is a continuation-in-part of application No. 19/177,834, filed on Apr. 14, 2025.
Application No. 19/177,834 is a continuation-in-part of application No. 19/093,546, filed on Mar. 28, 2025.
Application No. 19/093,546 is a continuation-in-part of application No. 19/079,851, filed on Mar. 14, 2025.
Application No. 19/079,851 is a continuation-in-part of application No. 19/056,456, filed on Feb. 18, 2025.
Application No. 19/056,456 is a continuation-in-part of application No. 19/023,647, filed on Jan. 16, 2025.
Application No. 19/023,647 is a continuation-in-part of application No. 18/978,188, filed on Dec. 12, 2024.
Application No. 18/978,188 is a continuation-in-part of application No. 18/958,107, filed on Nov. 25, 2024.
Application No. 18/958,107 is a continuation-in-part of application No. 18/940,944, filed on Nov. 8, 2024.
(60) Provisional application No. 63/714,353, filed on Oct. 31, 2024.
(60) Provisional application No. 63/720,216, filed on Nov. 14, 2024.
(60) Provisional application No. 63/750,817, filed on Jan. 29, 2025.
(60) Provisional application No. 63/750,822, filed on Jan. 29, 2025.

(51) Int. Cl. H04B 10/50; H04B 10/70

(52) U.S. Cl. CPC H04B 10/503; H04B 10/70

(57) ABSTRACT

Circuits and oxide-free quantum dot vertical-cavity surface-emitting lasers (OQ-VCSELs) are bonded to a front side of a directly modulated photonic wafer-scale interposer (PWSI). The PWSI includes waveguides for communication among the circuits and OQ-VCSELs. Electrical data is sent by a first circuit to an OQ-VCSEL. A degree of freedom (DoF) of a light beam emitted by the OQ-VCSEL is modulated. The degree of freedom can include an intensity, a phase, a mode, or a wavelength. The emitted light beam comprises a degree of freedom modulated beam (DFMB) that is based on the sent electrical data. The DFMB is coupled optically to a waveguide within the PWSI. The waveguide is further coupled to an optical decoding element. The DFMB is decoded by the optical decoding element into electrical data that was sent by the first circuit. The electrical data that was decoded is delivered to a second circuit.

### RELATED APPLICATIONS

This application is a continuation-in-part of U.S. patent application “Directly Modulated Photonic Wafer-Scale Interposer With Optical Links Based on Quantum Dot VCSELS” Ser. No. 19/290,530, filed Aug. 5, 2025.

The U.S. patent application “Directly Modulated Photonic Wafer-Scale Interposer With Optical Links Based on Quantum Dot VCSELS” Ser. No. 19/290,530, filed Aug. 5, 2025 is also a continuation-in-part of U.S. patent application “Optical Links On A Directly Modulated Photonic Wafer-Scale Interposer With Oxide-Free VCSELS” Ser. No. 19/289,269, filed Aug. 4, 2025.

The U.S. patent application: “Optical Links On A Directly Modulated Photonic Wafer-Scale Interposer With Oxide-Free VCSELS” Ser. No. 19/289,269, filed Aug. 4, 2025, is also a continuation-in-part of U.S. patent application “Dynamic Redundancy With Parallel Optical Links” Ser. No. 19/260,549, filed Jul. 6, 2025.

The U.S. patent application “Dynamic Redundancy With Parallel Optical Links” Ser. No. 19/260,549, filed Jul. 6, 2025, is also a continuation-in-part of U.S. patent application “Reduction Of Waveguide Crosstalk With Sub-Wavelength Structures” Ser. No. 19/260,471, filed Jul. 5, 2025.

The U.S. patent application “Reduction Of Waveguide Crosstalk With Sub-Wavelength Structures” Ser. No. 19/260,471, filed Jul. 5, 2025, is also a continuation-in-part of U.S. patent application “Disaggregated Memory Structures On A Directly Modulated Photonic Wafer-Scale Interposer” Ser. No. 19/243,462, filed Jun. 19, 2025.

The U.S. patent application “Disaggregated Memory Structures On A Directly Modulated Photonic Wafer-Scale Interposer” Ser. No. 19/243,462, filed Jun. 19, 2025, is also a continuation-in-part of U.S. patent application “Optical Links With Degree Of Freedom VCSEL Modulation On A Photonic Wafer-Scale Interposer” Ser. No. 19/235,870, filed Jun. 12, 2025.

The U.S. patent application “Optical Links With Degree Of Freedom VCSEL Modulation On A Photonic Wafer-Scale Interposer” Ser. No. 19/235,870, filed Jun. 12, 2025, is also a continuation-in-part of U.S. patent application “Optical Link With VCSEL Wavelength Modulation” Ser. No. 19/230,233, filed Jun. 6, 2025.

The U.S. patent application “Optical Link With VCSEL Wavelength Modulation” Ser. No. 19/230,233, filed Jun. 6, 2025, is also a continuation-in-part of U.S. patent application “Optical Link With Modulation Of VCSEL Modes” Ser. No. 19/223,614, filed May 30, 2025.

The U.S. patent application “Optical Link With Modulation Of VCSEL Modes” Ser. No. 19/223,614, filed May 30, 2025, is also a continuation-in part of U.S. patent application “Optical Link With Polarization-Switched VCSEL Modulation” Ser. No. 19/222,606, filed May 29, 2025.

The U.S. patent application “Optical Link With Polarization-Switched VCSEL Modulation” Ser. No. 19/222,606, filed May 29, 2025, is also a continuation-in-part of U.S. patent application “Hierarchical Redundancy With Parallel Optical Links” Ser. No. 19/211,446, filed May 19, 2025.

The U.S. patent application “Hierarchical Redundancy With Parallel Optical Links” Ser. No. 19/211,446, filed May 19, 2025, is also a continuation-in-part of U.S. patent application “Waveguides Based On Nanoimprint Lithography On A Photonic Wafer Scale Interposer” Ser. No. 19/210,116, filed May 16, 2025.

The U.S. patent application “Waveguides Based On Nanoimprint Lithography On A Photonic Wafer Scale Interposer” Ser. No. 19/210,116, filed May 16, 2025, is also a continuation-in-part of U.S. patent application “Photonic Wafer-Scale Interposer With Mirrors Based on Nanoimprint Lithography” Ser. No. 19/192,587, filed Apr. 29, 2025.

The U.S. patent application “Photonic Wafer-Scale Interposer With Mirrors Based on Nanoimprint Lithography” Ser. No. 19/192,587, filed Apr. 29, 2025, is also continuation-in-part of U.S. patent application “Photonic Wafer-Scale Interposer With Micro Transfer Printed VCSELS And Back Side Power Delivery” Ser. No. 19/192,146, filed Apr. 28, 2025.

The U.S. patent application “Photonic Wafer-Scale Interposer With Micro Transfer Printed VCSELS And Back Side Power Delivery” Ser. No. 19/192,146, filed Apr. 28, 2025, is also a continuation-in-part of U.S. patent application “Photonic Wafer Scale Interposer With Integrated Crystallographic Etched Mirrors And Pre-Angled Light” Ser. No. 19/189,471, filed Apr. 25, 2025.

The U.S. patent application “Photonic Wafer Scale Interposer With Integrated Crystallographic Etched Mirrors And Pre-Angled Light” Ser. No. 19/189,471, filed Apr. 25, 2025, is also a continuation-in-part of U.S. patent application “Photonic Wafer Scale Interposer With Angled Beam Grating Couplers” Ser. No. 19/188,057, filed Apr. 24, 2025.

The U.S. patent application “Photonic Wafer Scale Interposer With Angled Beam Grating Couplers” Ser. No. 19/188,057, filed Apr. 24, 2025, is also a continuation-in-part of U.S. patent application “Back Side Power Delivery For Wafer-Scale Integration With An Isometric Grid Array With Compression Pins” Ser. No. 19/177,834, filed Apr. 14, 2025.

The U.S. patent application “Back Side Power Delivery For Wafer-Scale Integration With An Isometric Grid Array With Compression Pins” Ser. No. 19/177,834, filed Apr. 14, 2025, is also a continuation-in-part of U.S. patent application “Back Side Power Delivery For Wafer-Scale Integration With Laser Assisted Bonding” Ser. No. 19/093,546, filed Mar. 28, 2025.

The U.S. patent application “Back Side Power Delivery For Wafer-Scale Integration With Laser Assisted Bonding” Ser. No. 19/093,546, filed Mar. 28, 2025, is also a continuation-in-part of U.S. patent application “Photonic Wafer-Scale Interposer With Tapered Waveguides” Ser. No. 19/079,851, filed Mar. 14, 2025.

The U.S. patent application “Photonic Wafer-Scale Interposer With Tapered Waveguides” Ser. No. 19/079,851, filed Mar. 14, 2025, is also a continuation-in-part of U.S. patent application “Back Side Power Delivery For Wafer-Scale Integration With An Isometric Grid Compression Plate” Ser. No. 19/056,456, filed Feb. 18, 2025, which claims the benefit of U.S. provisional patent applications “Chiplet-Based Optical Wafer-Scale Network Switch” Ser. No. 63/750,817, filed Jan. 29, 2025, and “Wafer-Scale Integration Power Delivery With An Isotropic Conductive Adhesive” Ser. No. 63/750,822, filed Jan. 29, 2025.

The U.S. patent application “Back Side Power Delivery For Wafer-Scale Integration With An Isometric Grid Compression Plate” Ser. No. 19/056,456, filed Feb. 18, 2025, is also a continuation-in-part of U.S. patent application “Back Side Power Delivery For Wafer-Scale Integration With Solderless Modular Power Substrates” Ser. No. 19/023,647, filed Jan. 16, 2025, which claims the benefit of U.S. provisional patent applications “Cooling For Wafer-Scale Integration With Back Side Power Coupling” Ser. No. 63/714,353, filed Oct. 31, 2024, and “Back Side Wafer-Scale Power Delivery With An Anisotropic Conductive Film” Ser. No. 63/720,216, filed Nov. 14, 2024.

The U.S. patent application “Back Side Power Delivery For Wafer-Scale Integration With Solderless Modular Power Substrates” Ser. No. 19/023,647, filed Jan. 16, 2025, is also a continuation-in-part of U.S. patent application “Wafer-Scale Integration With A Stiffening Isometric Grid Array” Ser. No. 18/978,188, filed Dec. 12, 2024, which claims the benefit of U.S. provisional patent applications “Cooling for Wafer-Scale Integration With Back Side Power Coupling” Ser. No. 63/714,353, filed Oct. 31, 2024, and “Back Side Wafer-Scale Power Delivery With An Anisotropic Conductive Film” Ser. No. 63/720,216, filed Nov. 14, 2024.

The U.S. patent application “Wafer-Scale Integration With A Stiffening Isometric Grid Array” Ser. No. 18/978,188, filed Dec. 12, 2024, is also a continuation-in-part of U.S. patent application “Cold Plate Cooling For Wafer-Scale Integration With Back Side Modular Power Delivery” Ser. No. 18/958,107, filed Nov. 25, 2024, which claims the benefit of U.S. provisional patent applications “Cooling for Wafer-Scale Integration With Back Side Power Coupling” Ser. No. 63/714,353, filed Oct. 31, 2024, and “Back Side Wafer-Scale Power Delivery With An Anisotropic Conductive Film” Ser. No. 63/720,216, filed Nov. 14, 2024.

The U.S. patent application “Cold Plate Cooling For Wafer-Scale Integration With Back Side Modular Power Delivery” Ser. No. 18/958,107, filed Nov. 25, 2024, is also a continuation-in-part of U.S. patent application “Back Side Wafer-Scale Integration With Modular Power Delivery” Ser. No. 18/940,944, filed Nov. 8, 2024, which claims the benefit of U.S. provisional patent application “Cooling for Wafer-Scale Integration With Back Side Power Coupling” Ser. No. 63/714,353, filed Oct. 31, 2024.

Each of the foregoing applications is hereby incorporated by reference in its entirety.

### FIELD OF ART

This application relates generally to transmitting data and more particularly to optical links with oxide-free quantum dot VCSELs on a directly modulated photonic wafer-scale interposer.

### BACKGROUND

Lasers have brought revolutionary changes in many technologies, industries, fields of medicine, and society at large. Since being invented in the last century, lasers have enabled the development of manufacturing and healing techniques that were previously unattainable. Lasers are used for creating, welding, or soldering mechanical and electronic components that are far smaller than can be detected by the unaided human eye. Specialized lasers are used for a variety of eye surgeries, such as YAG laser capsulotomy, to disperse clouded tissue in the eye that can develop after cataract surgery. Lasers are further used for corrective eye surgeries, enabling patients to see without corrective lenses. Lasers have also been used for entertainment purposes. Laser projectors are brighter and more stable over time compared to projectors that use LEDs or traditional lamps. Lasers are also found in some TVs and in “disk readers,” including audio, video, and data readers. Without a doubt, lasers have enabled vast improvements in many fields.

Perhaps the greatest technological advancements enabled by lasers are in the area of communications. Traditional, terrestrially based communications systems relied on cables. These cables, which were often made of copper, were deployed locally, regionally, nationally, and eventually internationally. The cables were originally used to send messages that were encoded using codes such as the Morse Code. Messages could be sent using “dots” (short pulse) and “dashes” (long pulse) that represented letters, numbers, punctuation, and “procedural signs.” The cables were then used for telephonic communication that enabled exchanging messages using voice. The telephonic communication also included music such as the ubiquitous and universally loathed music on hold (MOH). Then, in the latter part of the 20^{th} century, copper cables were used for sending and receiving data. The widespread introduction of computers into every aspect of personal life, whether the home, school, or the office, caused the rapid realization that communications based on copper cables were woefully inadequate to the task. As a result, the introduction of lasers for communication was vigorously pursued.

Laser-based communications systems rapidly proved their worth over the older copper cable systems. For telephonic communications, a laser-based system using a single fiber can carry approximately ten times the number of calls compared to the copper cable. For data communications, the number of “data channels” that can be supported on a copper cable is limited primarily by bandwidth and signal loss. By comparison, the number of data channels that can be carried on an optical fiber that is fed by a laser is typically exponentially greater. The number of data channels is increased on a fiber because of far wider bandwidth and significantly lower signal loss. Also, unlike cable-based systems, optical fibers are far less susceptible to electromagnetic interference. So, in addition to their communications system advantages, the optical fibers can be used in electromagnetically “noisy” environments including manufacturing facilities and hospital operating rooms. Thus, laser-based systems will continue to expand the capabilities of communication, manufacturing, medicine, and more.

### SUMMARY

Faster processor performance is demanded by today's users as they saturate the capabilities of current processor architectures and systems with ever more complex applications. These complex, computationally intensive applications, such as artificial intelligence (AI), climate modeling, genome sequencing, and so on, have been hobbled by current technological limitations of processors, systems-on-chip (SoCs), accelerators, servers, memory, power delivery, cooling technologies, and so on. Improved processing performance is certainly indicated. As an example, large language model (LLM) training time can easily extend to months, even while utilizing numerous processors and accelerators that are executing 24×7. Accomplishing needed processing improvements will require further advances in all system components. For example, communications between and among processors, accelerators, transformers, and so on must keep pace with the calculating abilities of these processing elements. When communications such as transmitting data do not keep pace, the processing elements become “starved” for data and stall. When processing elements stall, no matter their processing capabilities, overall system performance remains unimproved. Communication speed, power consumption, and heat dissipation, and so on are critical to overall system performance, whether related to high performance systems today or to future systems that have yet to be created.

Disclosed techniques enable improved data transmissions. The data transmission is based on optical links with oxide-free quantum dot VCSELs on a directly modulated photonic wafer-scale interposer. Circuits, such as chiplets and oxide-free quantum dot vertical-cavity surface-emitting lasers (OQ-VCSELs), are bonded to a front side of a modulated photonic wafer-scale interposer (PWSI). The PWSI includes waveguides that enable communication among the circuits, OQ-VCSELs, and other elements. Electrical data is sent by a first circuit to an OQ-VCSEL. The sending data is accomplished using wiring, interconnect, and so on that is on or within the PWSI. A degree of freedom (DoF) of a light beam is modulated. The DoF can include an intensity, a polarization, a mode, a wavelength, and so on. The modulated light beam is emitted by the OQ-VCSEL. The emitted light beam comprises a degree of freedom modulated beam (DFMB) that is based on the sent electrical data. The DFMB is coupled optically to a waveguide within the PWSI. The coupling optically can be accomplished using a mirror, a bent waveguide, an off-axis diffractive lens, or a grating coupler. The waveguide is further coupled to an optical decoding element that decodes the DFMB into the electrical data. The electrical data that was decoded is delivered to a second circuit.

A method for transmitting data is disclosed comprising: bonding, to a front side of a directly modulated photonic wafer-scale interposer (PWSI), a plurality of circuits and a plurality of oxide-free quantum dot vertical-cavity surface-emitting lasers (OQ-VCSELs), wherein the PWSI includes a plurality of waveguides; sending electrical data, by a first circuit within the plurality of circuits, to an OQ-VCSEL within the plurality of OQ-VCSELs; modulating a degree of freedom (DoF) of a light beam emitted by the OQ-VCSEL, wherein the emitted light beam comprises a degree of freedom modulated beam (DFMB), wherein the DFMB is based on the electrical data that was sent; coupling optically the DFMB to a waveguide within the plurality of waveguides, wherein the waveguide is further coupled to an optical decoding element; decoding, by the optical decoding element, the DFMB into the electrical data; and delivering the electrical data that was decoded to a second circuit within the plurality of circuits.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for optical links with oxide-free quantum dot VCSELs on a directly modulated photonic wafer-scale interposer.

FIG. 2 is a flow diagram for forming an active region within an oxide-free quantum dot VCSEL.

FIG. 3 is an example of a VCSEL with oxide.

FIG. 4 is an oxide-free quantum dot VCSEL with an ion implant.

FIG. 5 is an oxide-free VCSEL with a mesa.

FIG. 6 is a block diagram of an optical link with OQ-VCSEL modulation.

FIG. 7 is an apparatus for optical links on a directly modulated photonic wafer-scale interposer with oxide-free VCSELs.

FIG. 8 is a system diagram for optical links with oxide-free quantum dot VCSELs on a directly modulated photonic wafer-scale interposer.

### DETAILED DESCRIPTION

Techniques for transmitting data using optical links with oxide-free quantum dot VCSELs on a directly modulated photonic wafer-scale interposer are disclosed. Today's rapidly increasing demand for processing performance continues to strain the capabilities of current processors and other system elements. To meet these demands, high performance systems-on-chip (SoCs) have been designed that can include processors, memories, accelerators, switching elements, cores, and so on. These SoCs can boast transistor counts in the tens of billions. To further advance the vanguard of system-level performance, accelerators, such as artificial intelligence (AI) accelerators, have been designed to offload and quicken particularly challenging calculations. For example, today's large language models (LLMs) can rely on many such scaled-out accelerators to perform model training and inferencing. As raw processing power increases, the need for additional bandwidth and speed for accessing memory elements, other circuits, and so on also increases, leading to advancements such as application-specific circuit architectures.

The relentless exigency for obtaining increased processing performance has also propelled innovation in methods for interconnecting system elements. In the now distant past, simple bus architectures such as the Peripheral Component Interconnect (PCI) bus enabled sufficient bandwidth to keep processor elements provided with data, thus preventing the processor elements from stalling. However, as these system elements grew in their abilities to process more data more efficiently, so too did these elements grow physically, thus requiring more efficient methods of interconnection. For example, high speed serial links such as PCI Express (PCIe) enabled gigabit-per-second speeds on multiple “lanes.” As processing power has increased, optical communications have become a low power, high bandwidth alternative to wire-based designs for transferring data between processing elements. For example, multimode fibers enable remarkably high bandwidth, short-reach optical links which can be used between server racks, switches, storage, and so on.

Optical interconnect solutions have also been researched and developed to increase on-chip communications. For example, vertical-cavity quantum dot surface-emitting lasers (VCSELS) can be used to generate light-based communication within a chip, a wafer, an interposer, etc., with lower latency and wider bandwidth than traditional metal paths, especially when those paths are long. Traditionally, these VCSELS are fabricated with an oxide layer to define the active region. However, the oxide layer can introduce defects and strain at the oxide-semiconductor interface which can lead to reliability issues, especially in high power systems.

To address these issues, optical links with oxide-free quantum dot VCSELs on a directly modulated photonic wafer-scale interposer are disclosed. A plurality of circuits and a plurality of oxide-free quantum dot VCSELs (OQ-VCSELs) are bonded to a front side of a photonic wafer-scale interposer (PWSI). The PWSI further includes a plurality of waveguides that can be used for transmitting data. Electrical data is sent by a first circuit to an OQ-VCSEL. The first circuit can be a chiplet, an SoC, a wafer, an ASIC, a core, a core on a wafer, and so on. The first circuit can be a circuit within a chip, a chiplet, a system-on-chip (SoC), a wafer, etc. A degree of freedom (DoF) of a light beam emitted by the OQ-VCSEL is modulated. The degree of freedom can include an intensity of light, a polarization of light, a light mode, a light wavelength, and so on. The intensity, the polarization, the mode, and the wavelength can be based on one or more of asymmetric current injection, injected current, altered current, adjusted bias current, and so on. The emitted light beam from the OQ-VCSEL comprises a degree of freedom modulated beam (DFMB). The DFMB is based on the electrical data that was sent. The DFMB is coupled optically to a waveguide within the PWSI. The DFMB can be coupled optically to other optical media such as an optical fiber. The coupling optically can be accomplished by a mirror, such as a TMAH-etched mirror, a bent waveguide, an off-axis diffractive lens, a grating coupler, and so on. The coupling can include angling the DFMB that was emitted by the OQ-VCSEL. The angling can be based on a micro-optical element (MOE) such as a micro lens, a diffractive optical element, a Fresnel lens, an asymmetric non-focusing optical device, and so on.

The waveguide is further coupled to an optical decoding element (ODE). The ODE can comprise a mirror, a bent waveguide, an off-axis diffractive lens, a grating coupler, a polarization filter, a polarization multiplexor (PMUX), and so on. The ODE decodes the DFMB into the electrical data. In the case of a PMUX, a polarized beam splitter (PBS) can separate the DFMB into at least two polarized optical signals. The PBS can be within the PMUX. The separating can be based on a plane of polarization of the PMB. Each polarized optical signal, optical mode, or optical wavelength can be transformed by a unique photodiode. The transforming can result in at least two electrical signals. These electrical signals can be assembled into a single electrical signal. The single electrical signal can comprise the electrical data that was sent. The electrical data that was decoded is delivered to a second circuit, which can be a chiplet, an SoC, a wafer, an ASIC, a core, a core on a wafer, and so on. The second circuit can comprise a circuit within a chip, a chiplet, an SoC, a wafer, etc. The first chiplet, the second chiplet, and the OQ-VCSEL can be within a plurality of chiplets bonded to a front side of a photonic wafer-scale integrations interposer (PWSI). The PWSI can include a plurality of waveguides. The waveguide can comprise a waveguide within the plurality of waveguides. Other optical media can be used. The optical medium can include an optical fiber.

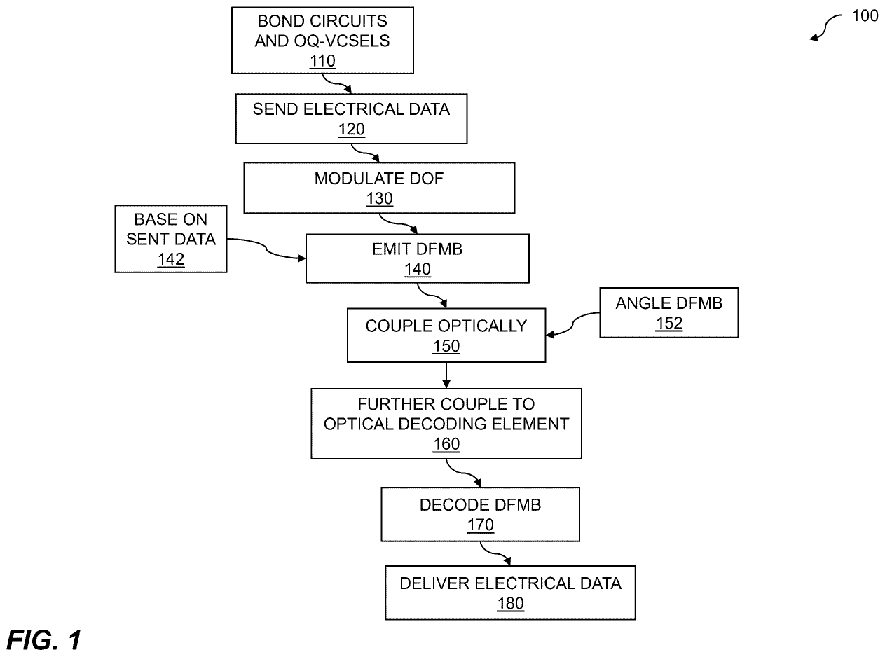

FIG. 1 is a flow diagram for optical links with oxide-free quantum dot VCSELs on a directly modulated photonic wafer-scale interposer. The flow 100 includes bonding circuits and OQ-VCSELS 110. Embodiments include bonding, to a front side of a directly modulated photonic wafer-scale interposer (PWSI), a plurality of circuits and a plurality of oxide-free quantum dot vertical-cavity surface-emitting lasers (OQ-VCSELs), wherein the PWSI includes a plurality of waveguides. The plurality of circuits can include chiplets that perform a variety of functions such as artificial intelligence (AI) acceleration, switching, data processing of various data types, I/O, and so on. The plurality of circuits can include cores such as processor cores, cores fabricated on or coupled to a wafer, and the like. The PWSI includes a plurality of waveguides. The waveguides can be used to transmit data between circuits. In a usage example, at least one waveguide in the plurality of waveguides can include a first distance. The first distance can be greater than an exposure, on the PWSI, of a single photomask reticle. To accommodate longer paths, the waveguides can be manufactured via nanoimprint lithography (NIL), or another suitable fabrication technology. In a usage example, fabricating the plurality of waveguides can be accomplished with reticle stitching or other techniques that are not based on reticle stitching.

A circuit can comprise a chiplet, an SoC, a wafer, an ASIC, a core, a core on a wafer, a circuit within a chip, a chiplet, an SoC, a wafer, and so on. The plurality of circuits can comprise a plurality of chiplets. The oxide-free quantum dot vertical-cavity surface-emitting lasers (OQ-VCSELs) include OQ-VCSELs that can be modulated. Thus, the PWSI can comprise a directly modulated PWSI. The bonding the circuits and the OQ-VCSELs to the PWSI can be accomplished using soldering techniques, adhesives, elastomeric sheets, laser assisted bonding, and other techniques that enable coupling the circuits and the OQ-VCSELs to the PWSI. The coupling the circuits and the OF-VCSELs enables electrical coupling to pads, wire, interconnect, and vias associated with the PWSI. The coupling further enables access to the waveguides within the PWSI.

An OQ-VCSEL can be a semiconductor laser which can be fabricated on a chip. The OQ-VCSEL can comprise an OQ-VCSEL array. The OQ-VCSEL array can include a plurality of OQ-VCSELs. The fabrication can be based on gallium arsenide or another suitable material. In some embodiments, a substrate associated with each OQ-VCSEL within the plurality of OQ-VCSELs comprises gallium arsenide (GaAs). The OQ-VCSEL can emit light in a direction perpendicular to the chip. The direction can be up (e.g., away from the chip) or down (e.g., into the chip). When light is emitted down, a window can be provided so that the light can escape through the back of the chip. To aid projection of the light, the substrate of the chip can be thinned. OQ-VCSELs include quantum dots. In embodiments, each OQ-VCSEL within the plurality of OQ-VCSELs includes one or more quantum dots within an active region, wherein the one or more quantum dots confine a plurality of carriers in three dimensions. A quantum dot can comprise a semiconductor particle that can exhibit behavior similar to that of an individual atom (e.g., discrete atomic energy levels). Since the confinement can be different from a quantum well VCSEL, an OQ-VCSEL can exhibit better electrical characteristics such as lower threshold current, sharper gain spectrum, better temperature sensitivity, and so on. Quantum dots can be manufactured to emit specific wavelengths of light by modifying various properties of the quantum dots including shape, size, and transparency.

The OQ-VCSEL can include an active region that is not defined by an oxide layer. Instead, the active region can be developed by various methods such as ion implantation, depositing an out-of-phase gain medium, lithographic patterning, fabricating one or more buried tunnel junctions, including one or more subwavelength gratings, using one or more photonic crystals, using regrowth with an edge stop, building one or more mesas, and so on. The aforementioned methods can define one or more sub-regions within the active region of the QD-VCSEL. In embodiments, the active region associated with the VCSEL can include at least two sub-regions, where the sub-regions can include a first rate of lasing activity and a second rate of lasing activity. The second rate of lasing activity or the first rate of lasing activity can be 0. The resulting oxide-free VCSEL (OQ-VCSEL) can be used in place of a VCSEL that includes an oxide layer.

The flow 100 includes sending electrical data 120. Embodiments include sending electrical data, by a first circuit within the plurality of circuits, to an oxide-free quantum dot vertical-cavity surface-emitting laser (OQ-VCSEL) within the plurality of OQ-VCSELs. The first circuit can be a circuit within a chip, a core, a chiplet, an SoC, a wafer, an interposer, etc. The first circuit can comprise a processor, a multi-core processor, a memory controller, a memory chip such as DDR or HBM, an I/O chip, an AI accelerator, a switching chip, and so on. The first circuit can further comprise a core, a core on a wafer, etc. The first circuit and the OQ-VCSEL can be on the same or different circuit boards, interposers, wafers, etc. Noted previously, the first circuit and the OQ-VCSEL can be bonded to a front side of the photonic wafer-scale interposer. The sending can be accomplished using any means to communicate between chips. For example, the sending can be based on routes such as wire routes on a printed circuit board, a bus interface, a wireless communication protocol such as Bluetooth™, metal layers on a wafer or a wafer interposer, and so on. The electrical data can comprise serialized data, data packets, handshaking signals, etc. An OQ-VCSEL can be a semiconductor laser fabricated on a chip. The OQ-VCSEL can comprise an OQ-VCSEL array. The fabrication can be based on gallium arsenide or another suitable material. The OQ-VCSEL can emit light in a direction perpendicular to the chip. The direction can be up (e.g., away from the chip) or down (e.g., into the chip). When light is emitted down, a window or aperture can be provided so that the light can escape through the back of the chip. To aid projection of the light, the substrate of the chip can be thinned. The light that is emitted can be coherent light that is in a wavelength range, such as 850 nm-950 nm. Other ranges are possible. In embodiments, a wavelength of the emitted light beam can be substantially 1.3 μm.

The flow 100 includes modulating a property of light 130. The property of light that is modulated includes a degree of freedom (DoF) of a light beam emitted by the OQ-VCSEL. Embodiments include modulating a degree of freedom (DoF) of a light beam emitted by the OQ-VCSEL, wherein the emitted light beam comprises a degree of freedom modulated beam (DFMB), wherein the DFMB is based on the electrical data that was sent. The modulating a degree of freedom can include modulating an intensity of the OQ-VCSEL, modulating a polarization of the OQ-VCSEL, modulating a mode of the OQ-VCSEL, modulating a wavelength of the OQ-VCSEL, and so on. The modulating a property of the light causes the OQ-VCSEL to emit a light beam based on the degree of freedom. The resulting emitted light beam comprises a degree of freedom modulated beam (DFMB). The DFMB can include one or more of a polarization of light, a mode of light, a wavelength of light, an intensity of light, etc. The DFMB is based on the electrical data that was sent. The modulation can include adjusting properties of light emission of the OQ-VCSEL to encode optical data. The modulation can also include changing a degree of freedom, during transmission, of the light emitted by the OQ-VCSEL. The modulating can be based on multiplexing techniques such as a time division multiplexing (TDM) technique. The TDM technique can enable sending of multiple degree of freedom signals by assigning a time slot to each degree of freedom signal.

In some embodiments, the degree of freedom comprises an intensity of the OQ-VCSEL. For example, the modulation can be based on current. Adjusting the current applied to an active region of the OQ-VCSEL can turn light emission on/off or change the intensity of the emitted light. When the current is below a threshold, lasing action can be stopped. When current levels return to a level exceeding the threshold, lasing can restart. As current is increased, a brightness, or optical power, of the OQ-VCSEL can be increased. The detection of a presence or absence of light from the OQ-VCSEL can be used to encode a “1” or “0” in the form of a light wave. The intensity of the OQ-VCSEL can be modulated by adjusting current to the OQ-VCSEL. The current can be adjusted above and below the threshold to enable or disable lasing, respectively. Alternatively, the modulating can include increasing and decreasing current to increase and decrease intensity, respectively. The increase or decrease in intensity can also be interpreted as a “1” or “0.”

In some embodiments, the degree of freedom comprises a polarization of the OQ-VCSEL. Polarization can refer to an orientation of an oscillating light wave. The polarization can include linear polarization, circular polarization, elliptical polarization, etc. In some embodiments, the modulation is based on asymmetric current injection. The polarization can be controlled by asymmetric current injection. Asymmetric current injection can include sending current into an active region of the OQ-VCSEL in a non-uniform way. The non-uniformity can influence the OQ-VCSEL to produce polarized light in a first direction. The applied current can be altered to produce polarized light in a second direction. The asymmetric current injection can include a current with a DC offset, a current that includes an asymmetric wave, and the like. Polarization of light emitted from the OQ-VCSEL can also be accomplished with a ferroelectric liquid crystal layer. The OQ-VCSEL can include a ferroelectric liquid crystal layer (FLC). The FLC can include liquid crystals that can be oriented by an electric field. Applying a voltage to the FLC can also influence the polarization of light emitted by the OQ-VCSEL. The FLC can include a bottom and middle Distributed Bragg Reflector (DBR) with the FLC layer on top of the middle layer. A top DBR can be included on top of the FLC layer. Other layouts are possible.

In some embodiments, the degree of freedom comprises a mode of the OQ-VCSEL. The degree of freedom can include a mode such a transverse electromagnetic (TEM) mode. A TEM can indicate a distribution of the electrical field emitted from the OQ-VCSEL in a plane perpendicular to the direction of the emission. In a usage example, the TEM mode can include TEM₀₀, TEM₁₀, TEM₀₁, and so on. The TEM modes can include a fundamental mode, a low order mode, a high order mode, and so on. The fundamental mode of the OQ-VCSEL can comprise a higher order mode than a non-fundamental mode. The mode of the OQ-VCSEL can be changed by altering current. The modulating can comprise altering current to the OQ-VCSEL. The OQ-VCSEL can comprise a multimodal OQ-VCSEL. A multimodal OQ-VCSEL can support a plurality of modes which can be altered by the modulating. A logic “1” can be assigned to a first mode while a logic “0” can be assigned to a second mode. In this way, optical data can be encoded and decoded.

In some embodiments, the degree of freedom comprises a wavelength of the OQ-VCSEL. That is, the degree of freedom can include a wavelength of light emitted from the OQ-VCSEL. The wavelength can be modulated based on current injection. The modulating can comprise injecting current into the OQ-VCSEL. The injecting current can enable degree of freedom modulation based on wavelength of light. The injecting current can affect the wavelength emitted by the OQ-VCSEL by changing a density of carriers within the active area. The modulating can be based on OQ-VCSEL chirp. OQ-VCSEL chirp can refer to a change in emission wavelength of an OQ-VCSEL due to injecting current, changing current, varying current, etc. The wavelength can also be modulated by altering a bias current to the OQ-VCSEL. The injecting can include altering a bias current to the OQ-VCSEL.

Noted above, the modulating causes the OQ-VCSEL to emit a light beam. In the flow 100, the emitted light beam comprises a degree of freedom modulated beam (DFMB) 140. A DFMB can result from modulating an intensity of the light, a plane of polarization of the light, a mode of the light, a wavelength of the light, etc., as described above. The DFMB can comprise an optical signal whose degree of freedom changes over time, thus encoding optical information. The degree of freedom of the beam can be sensed, allowing for the decoding of the information that is sent. Recall that electrical data is sent by a first circuit to an OQ-VCSEL. The electrical data can be used to modulate a degree of freedom of the OQ-VCSEL by disclosed techniques, resulting in a DFMB sent from the OQ-VCSEL. Thus, in the flow 100, the DFMB is based on the electrical data that was sent 142.

The flow 100 includes coupling optically 150. Embodiments include coupling optically the DFMB to a waveguide within the plurality of waveguides, wherein the waveguide is further coupled to an optical decoding element. The DFMB can be coupled optically to other optical media such as an optical fiber. An optical medium can be any material, space, etc. that allows an optical signal, such as a DFMB, to propagate. The waveguide can include a waveguide within a wafer, an interposer, and so on. Other optical mediums can be used. In a usage example, a fiberoptic cable is used as an optical medium to send an optical signal from a transmitter to a receiver. In another usage example, the optical medium comprises a degree of freedom maintaining fiber. The degree of freedom can include an intensity of light, a polarization of light, a light mode, a light wavelength, etc. The degree of freedom maintaining fiber can maintain fidelity of the DFMB. The first circuit and the OQ-VCSEL can be bonded to a photonic wafer-scale interposer (PWSI) which includes a plurality of waveguides to carry optical signals from one or more OQ-VCSELs. The optical medium can comprise a waveguide within the plurality of waveguides. Recall that the OQ-VCSEL can emit optical signals, such as the DFMB, in a vertical direction. The vertical direction can be down, toward the substrate (and the PWSI to which an OQ-VCSEL can be bonded). A waveguide within the PWSI can be oriented horizontally or substantially horizontally. Thus, the DFBM can be coupled to the waveguide in order for it to propagate along the waveguide to another circuit bonded to the PWSI, such as a second chiplet.

In some embodiments, the coupling optically is based on a grating coupler. The grating coupler can diffract light at specific frequencies, input angles, etc. thereby providing efficient transfer of light at a specific frequency into or out of a waveguide. To aid the coupling to a grating coupler, the DFMB emitted from the OQ-VCSEL can be angled 152. Embodiments include angling the PMB that was emitted by the OQ-VCSEL, wherein the angling is based on a micro-optical element (MOE). The MOE can be based on one or more optical techniques. For example, the MOE can comprise a micro lens. The micro lens can be coupled to the first surface-emitting light source such as an OQ-VCSEL, an LED, a laser diode, and so on. The micro lens can pre-angle the emitted light. The MOE can comprise a diffractive optical element. The diffractive optical element can create a light phase profile that can focus, shape, or split the emitted light. The MOE can include a Fresnel lens. The Fresnel lens can use concentric grooves or rings to focus the emitted light. The MOE can include an asymmetric non-focusing optical device. The asymmetric non-focusing optical device can enable light to transmit through the device preferentially, where the light can pass through more easily in one direction than another direction. The asymmetric non-focusing optical device can couple light to a waveguide and can suppress a portion of reflected light back to the surface-emitting light source. Any number and/or types of MOEs can be used in conjunction with any number of OQ-VCSELS.

Other methods of coupling the DFMB to the waveguide, or another optical medium such as an optical fiber, can be implemented. In embodiments, the coupling optically is based on a mirror. The mirror can include a mirror within a circuit, a chip, a wafer, an interposer, and so on. In a usage example, the coupling is based on a crystallographic etched mirror. The crystallographic etched mirror can comprise a tetramethylammonium hydroxide (TMAH) etched mirror. The TMAH mirror can reflect incoming light at a 54.74 degree angle, or substantially a 54.75 degree angle, to the waveguide. Other angles are possible with various mirrors. A mirror, such as a crystallographic etched mirror, can operate in combination with an MOE, such as described above, which can be placed over or near an aperture of the OQ-VCSEL. For example, the MOE can pre-angle light from the OQ-VCSEL so that when the light is reflected by the TMAH mirror, it is efficiently coupled directly into the waveguide at 90 degrees, or sufficiently close to 90 degrees, from the light source. In other embodiments, the coupling optically is based on a bent waveguide. The bent waveguide can include a high containment region of a waveguide. The high containment waveguide can redirect the light while minimizing loss of light in the region of the bend of the waveguide. In further embodiments, the coupling optically is based on an off-axis diffractive lens. An off-axis diffractive lens can direct light at an angle with respect to the optical axis of the lens. An off-axis diffractive lens can direct the DFMB at an angle substantially normal to an input aperture of the waveguide into the waveguide.

In the flow 100, the waveguide is further coupled to an optical decoding element (ODE) 160. An ODE can be an optical element that interprets a degree of freedom state of an optical signal. The ODE can be used to decode the DFMB at the far end of the waveguide. The flow 100 includes decoding the DFMB 170. Embodiments include decoding, by the optical decoding element, the DFMB into the electrical data. In a usage example, the DFMB is decoded, by the ODE, into the electrical data that was sent by the first circuit. The ODE can be based on a variety of optical techniques. The optical decoding element can comprise a grating coupler. The grating coupler can separate different polarizations, wavelengths, modes, etc. from each other. In a usage example, the separated polarizations of light can be sent to optical receivers, where the optical receivers can convert the optical data to electrical data. The optical decoding element can comprise a polarization filter. A polarization filter can enable passage of light with a polarization that is compatible with the polarization filter while substantially blocking light with polarizations that are incompatible with the polarization filter. In a usage example, a first polarization filter passes light polarized with a first polarization, and a second polarization filter passes light polarized with a second polarization. The optical decoding element can comprise a polarization multiplexor (PMUX). The PMUX can receive light that includes two or more polarizations. The received light can be separated into two or more beams, where each beam is based on a single polarization (explained in further detail below). In a usage example, the decoding can be based on time-division demultiplexing (TDDM). The TDDM can reassemble two or more signals that were time-multiplexed before sending through the waveguide, optical fiber, etc.

The flow 100 includes delivering electrical data 180. Embodiments include delivering the electrical data that was decoded to a second circuit within the plurality of circuits. The second circuit can comprise a chiplet. As was the case with the first circuit, the second circuit can be a circuit within a chip, a core, a chiplet, an SoC, a wafer, an interposer, etc. The second circuit can comprise a processor, chiplet, multi-core processor, memory controller, memory chip such as DDR or HBM, I/O chip, AI accelerator, switching chip, and so on. The second circuit and the first circuit can be on the same or different circuit boards, interposers, wafers, etc. The electrical data can be delivered to the second circuit using a variety of techniques. The delivery techniques can be based on using wire, interconnect, metal layers, and so on. The metal layers can include metal layers within a circuit board, a wafer, an interposer, and so on. The interposer can include a photonic wafer-scale interposer. The metal layers, which enable interconnection between and among circuits, chiplets, and other elements, can be fabricated on or within a circuit board, wafer, or interposer. As was the case for sending the data from the first circuit to the VCSEL, using the metal layers can offer significant inter-chiplet communications speed due to short wire lengths, and reduced “parasitics” such as resistance, capacitance, and inductance. The second circuit can process the delivered data, forward the delivered data, etc.

Various steps in the flow 100 may be changed in order, repeated, omitted, or the like without departing from the disclosed concepts. Various embodiments of the flow 100, or portions thereof, can be included in an apparatus for transmitting data or system that is configured to transmit data.

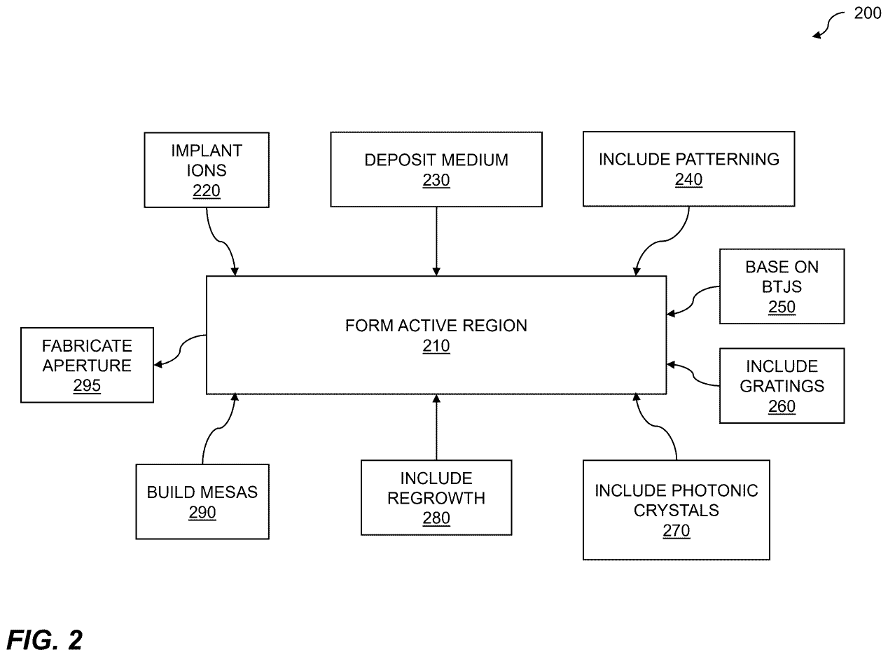

FIG. 2 is a flow diagram for forming an active region within an oxide-free quantum dot VCSEL. Discussed previously and throughout, vertical-cavity surface-emitting lasers (VCSELs), such as oxide-free quantum dot VCSELs (OQ-VCSELs), can enable transmitting data between circuits. A VCSEL can convert electrical data sent from a first circuit to optical data. The optical data can be sent via a waveguide to a decoder, where the decoder can decode the optical data into electrical data. The electrical data can be delivered to a second circuit. A VCSEL includes an active area, where the active area generates and amplifies light. The generated light can be modulated, where the modulating the light can be based on various degrees of freedom such as light intensity, light polarization, light mode, light wavelength, and so on. Transmitting data as light is enabled using optical links with oxide-free quantum dot VCSELs on a directly modulated photonic wafer-scale interposer.

An OQ-VCSEL can be a semiconductor laser which can be fabricated on a chip. The OQ-VCSEL can comprise an OQ-VCSEL array. The OQ-VCSEL array can include a plurality of OQ-VCSELs. The OQ-VCSELs include quantum dots. In embodiments, each OQ-VCSEL within the plurality of OQ-VCSELs includes one or more quantum dots within an active region, wherein the one or more quantum dots confine a plurality of carriers in three dimensions. A quantum dot can comprise a semiconductor particle that can exhibit behavior similar to that of an individual atom (e.g., discrete atomic energy levels). Since the confinement can be different from a quantum well VCSEL, an OQ-VCSEL can exhibit better electrical characteristics such as lower threshold current, sharper gain spectrum, better temperature sensitivity, and so on. Quantum dots can be manufactured to emit specific wavelengths of light by modifying various properties of the quantum dots including shape, size, and transparency. The OQ-VCSEL can include an active region that is not defined by an oxide layer. Instead, the active region can be developed by various methods such as ion implantation, depositing an out-of-phase gain medium, lithographic patterning, fabricating one or more buried tunnel junctions, including one or more subwavelength gratings, using one or more photonic crystals, using regrowth with an edge stop, building one or more mesas, and so on. The aforementioned methods can define one or more sub-regions within the active region of the QD-VCSEL. In embodiments, the active region associated with the VCSEL can include at least two sub-regions, where the sub-regions can include a first rate of lasing activity and a second rate of lasing activity. The second rate of lasing activity or the first rate of lasing activity can be 0. The resulting oxide-free VCSEL (OQ-VCSEL) can be used in place of a VCSEL that includes an oxide layer.

Circuits and oxide-free quantum dot vertical-cavity surface-emitting lasers (OQ-VCSELs) are bonded to a photonic wafer-scale interposer (PWSI). The PWSI includes waveguides that can be used to communicate among the circuits, the OQ-VCSELs, and other elements associated with the PWSI. Electrical data is sent by a first circuit to an OQ-VCSEL. A degree of freedom (DoF) of a light beam is modulated. The light beam is emitted by the OQ-VCSEL. The light beam comprises a degree of freedom modulated beam (DFMB) that is based on the electrical data that was sent. The DFMB is coupled to a waveguide. The waveguide is further coupled to an optical decoding element. The optical decoding element decodes the DFMB into the electrical data. The electrical data is delivered to a second circuit.

The flow 200 includes forming an active region 210. Some embodiments include forming an active region within the OF-VCSEL. The active region enables light generation and amplification within the OQ-VCSEL. The light generation and amplification can be accomplished using a variety of techniques. In embodiments, each OQ-VCSEL within the plurality of OQ-VCSELs includes one or more quantum dots within an active region, wherein the one or more quantum dots confine a plurality of carriers in three dimensions. A size of a quantum dot can be configured to enable desirable electrical and optical properties. In a usage example, a quantum dot can be sized to emit a desired color of light. The confinement of carriers, where carriers can include electrons or holes (e.g., an absence of electrons), can result in unique energy levels that can be similar to energy levels in atoms. The confinement can enable a color of light emitted by the quantum dot. Various colors or wavelengths of light can be emitted. In some embodiments, a wavelength of the emitted light beam can be substantially 1.3 μm.

The active region can be between mirrors. The mirrors can include Distributed Bragg Reflector (DBR) mirrors. The active region within an OQ-VCSEL can include sub-regions. In some embodiments, the active region of at least one OQ-VCSEL within the plurality of OQ-VCSELs comprises at least two sub-regions, wherein a first sub-region within the at least two sub-regions includes a first rate of lasing activity, and wherein a second sub-region within the at least two sub-regions includes a second rate of lasing activity. The subregions can be used to modulate a light beam emitted by an OQ-VCSEL (discussed throughout). For example, one subregion within the active region of an OF-VCSEL can be fabricated with a higher resistance. The higher resistance can limit lasing activity in that region in comparison to other regions with lower resistance.

Various techniques can accomplish forming an active region within an OQ-VCSEL. In some embodiments, the forming includes implanting a plurality of ions 220 within the active region. A variety of ions can be implanted to form the active region. In some embodiments, the implanting can be based on zinc. Other ions that can be implanted can include hydrogen, fluorine, oxygen, nitrogen, etc. The active region can generate photons and can enable gain. Light that is emitted by the OQ-VCSEL can be generated within the active region. The implanted ions can create a high resistivity region within the active region of the OQ-VCSEL. The implanted ions can accomplish current containment within the active region of the OQ-VCSEL. The implanted ions can also accomplish optical containment. The current confinement and the optical confinement can hold injected carriers and generated photons in close proximity, thereby accomplishing more efficient amplification and radiative recombination.

In other embodiments, the forming can include depositing 230, within the active region, an out-of-phase gain medium. The out-of-phase gain medium can include a region of the active region of a VCSEL where the gain of that region of the active region has been manipulated to be out of phase with respect to a pattern of a standing wave within the unmanipulated active area. That is, the manipulated region can be out of phase with respect to an anticipated resonant standing wave pattern of the laser cavity (e.g., quantum dots). In a usage example, the depositing an out-of-phase gain medium can shift the wavelength of a peak gain relative to the resonance of the cavity.

In some embodiments, the forming includes lithographic patterning 240. The lithographic patterning can be accomplished using a technique such as nano-imprint lithography (NIL). The lithographic patterning can include epitaxial crystal growth and other lithographic techniques to define the active region of the OF-VCSEL. The lithographic patterning can be used to form mirrors within a wafer, an interposer, and so on. The patterning can enable forming sub-wavelength gratings on mirrors on or within a wafer or interposer. The patterning on the mirrors can be highly precise. The sub-wavelength grating can be used to reduce or prevent polarization flipping within a VCSEL. Thus, the lithographic patterning can control a polarization of a VCSEL. The lithographic patterning can enable single-mode operation of the VCSEL. The lithographic patterning can further enable VCSEL efficiency.

In other embodiments, the forming is based on one or more buried tunnel junctions (BTJs) 250. A buried tunnel junction can include a structure for accomplishing electrical contact and current confinement. A BTJ can comprise a pn-junction that is heavily doped. The BTJ can be placed adjacent to material comprising a heavily doped n-material. The heavily doped pn-junction can enable current injection into the active region of the VCSEL under reverse bias. The current injection can be accomplished based on band-to-band tunneling. Under reverse bias conditions, the energy bands of the pn-junction and the n-material can align to enable direct tunneling of electrons through the junction.

In some embodiments, the forming includes one or more sub-wavelength gratings 260. A sub-wavelength grating can include a periodic structure. In a usage example, the periodic structure can be formed using a nano-imprint lithography (NIL) technique. The sub-wavelength grating can act as a reflector or mirror in a VCSEL. By designing the grating for a wavelength smaller than the wavelength of light produced by a VCSEL, the grating can accomplish high reflectivity, light polarization selectivity, and so on. In a usage example, a sub-wavelength grating can be used as a top mirror in an OQ-VCSEL.

In some embodiments, the forming includes one or more photonic crystals 270. A photonic crystal can include a structure that can be etched into the top mirror of a VCSEL. Recall that the top mirror of the VCSEL can include a Distributed Bragg Reflector (DBR). The photonic crystal can vary a refractive index of the top mirror by creating a periodic variation in the refractive index. The photonic crystal can enhance optical confinement of light within a laser cavity. The structure created by the design of photonic crystals can enable single-mode operation of the VCSEL which can preferentially enable light emitted by the VCSEL to include a single, well-defined beam of light.

In some embodiments, the forming includes regrowth with an etch stop 280. Regrowth in regard to VCSEL fabrication can include epitaxial growth of layers associated with the VCSEL. Portions of an epitaxially grown layer can be selectively etched, and new layers can be regrown. The etching technique can be controlled by carefully locating an etch stop layer. The etch stop layer can prevent damage by an etchant to underlying layers during an etching technique. The regrowth and etch stop steps can enable precise formation of VCSEL structures such as trenches, mesas (discussed below), and so on. The regrowth and etch stop techniques can enable precise structuring and etching, controlled removal of one or more layers, and reduction of damage and defects.

In some embodiments, the forming includes building one or more mesas 290, wherein the one or more mesas define a current confinement region within the active region of each OQ-VCSEL. A structure such as a mesa can be formed by removing a portion of a semiconductor material on which an OQ-VCSEL is fabricated. The removing a portion of the material can be accomplished using a technique such as etching. The etching can be accomplished using a wet etch technique or a dry etch technique. The raised area or “mesa” that results from the etching can define an active region of an OQ-VCSEL. The mesa can improve OQ-VCSEL performance by controlling current confinement and optical confinement.

Other embodiments include fabricating an aperture 295 within the OQ-VCSEL separately from the active region. The aperture or window is used by the OQ-VCSEL to emit a beam of light. The beam of light can include a modulated beam, where the modulated beam can comprise a degree of freedom modulated beam. The aperture of the OQ-VCSEL can be formed using a variety of techniques. Recall that the substrate to which the VCSEL is coupled can be thinned in order to enable forming of the aperture. In a usage example, a selective oxidation technique can be used to form the aperture. Selective oxidation can include partial oxidation of a layer within the DBR mirror stack. The selective oxidation can include oxidation of a high-aluminum content layer within an AlGaAs stack of the DBR. The oxidation can include controlled lateral oxidation. The resulting oxide region can include a high resistivity region which acts as an insulator with a refractive index lower than the unoxidized region. The unoxidized region can form the aperture, where the aperture can confine the electrical current and an optical mode within the active region of the OQ-VCSEL.

Various steps in the flow 200 may be changed in order, repeated, omitted, or the like without departing from the disclosed concepts. Various embodiments of the flow 200, or portions thereof, can be included in an apparatus for transmitting data or system that is configured to transmit data.

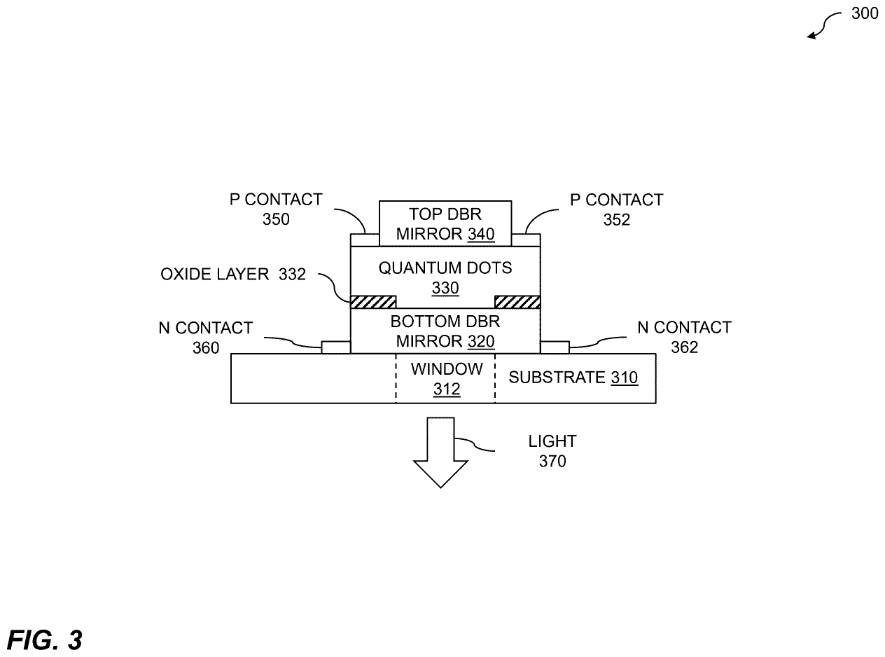

FIG. 3 is an example of a VCSEL with oxide. A VCSEL can be used to transmit data between system elements such as circuits, memory devices, AI accelerators, switches, and so on. The block diagram 300 includes a substrate 310. The substrate can include a variety of materials suitable to fabricating a VCSEL. In a usage example, the substrate can include a gallium arsenide (GaAs) substrate. Other materials that can be used for the substrate can include aluminum-gallium-arsenide (AlGaAs), germanium (Ge), sapphire, and so on. The substrate can include a thinned substrate. The substrate can be thinned to enable fabrication of an aperture or window 312. The thinning of the substrate can be accomplished by grinding, polishing, etching, and so on. Light in the form of a degree of freedom-modulated beam (DFMB) is emitted by the VCSEL. The light emitted by the VCSEL can exit the VCSEL by passing through the window in the substrate.

The VCSEL structure comprises an active region that is placed between two highly reflective mirrors. The active region can include a gain medium for the VCSEL. The first mirror includes a first reflectivity, and the second mirror includes a second reflectivity. In a usage example, the two highly reflective mirrors can be based on Distributed Bragg Reflectors (BDRs). These mirrors can be formed from multiple, alternating layers of materials, where the materials have different refractive indices. The block diagram 300 includes a bottom mirror 320. The bottom mirror can comprise an n-Distributed Bragg Reflector. The bottom mirror can include a reflectivity that is lower than a top mirror (described below). In a usage example, the lower reflectivity of the bottom mirror can include a reflectivity of 93 percent to 99 percent, or another suitable reflectivity. The n-Distributed Bragg Reflectors associated with the bottom mirror can be insulated from other layers in the block diagram by an oxide layer (discussed below).

Some embodiments can include forming an active region within the VCSEL. The active region can enable gain, where the gain can amplify an amount of photons that can be emitted as a beam of light from the VCSEL. The active region can comprise a plurality of quantum dots 330. The active region of a VCSEL with oxide can comprise other structures, such as quantum wells. Within the active region, the plurality of quantum dots can generate photons that are emitted as a light beam by the VCSEL. The active region can include a semiconductor material in which quantum dots can be formed. In a usage example, the quantum dots can be based on a semiconductor material such as gallium arsenide (GaAs), indium-gallium-arsenide (InGaAs), aluminum-gallium-arsenide (AlGaAs), and so on.

The active region can be sandwiched between Distributed Bragg Reflectors (DBRs). The active region 330 can include an oxide layer 332. The oxide layer can enhance the gain medium. In a usage example, the oxide layer can enable current confinement. The oxide layer restricts the flow of current to a small region of the active region (e.g., a gain medium), thereby accomplishing high current densities in proximity to the active region. In another usage example, the oxide layer can accomplish optical confinement by enabling a change in refractive index. The change in refractive index can act as a waveguide. In a further usage example, the oxide layer can enhance lasing efficiency. The current confinement and the optical confinement can hold injected carriers and generated photons in close proximity, thereby accomplishing more efficient amplification and radiative recombination.

The active region can be located within a laser cavity. The block diagram 300 can include an additional oxide layer (not shown) between the active region and a top DBR mirror. The oxide layer between the bottom mirror and the active area, and the oxide layer between the active layer and the top mirror, may or may not be present in the VCSEL. When present, the oxide layers can confine the light and electrical current within the active area. The VCSEL includes a top mirror 340. The top mirror can comprise a p-Distributed Bragg Reflector mirror. The top mirror can include a high reflectivity. In a usage example, the reflectivity of the top DBR can include a reflectivity of 99.4 percent to 99.9 percent. Other suitable reflectivities can be implemented.

An electrical current is applied to the VCSEL in order for the VCSEL to lase. The lasing of the VCSEL enables emission of coherent light. The applied electrical current can include a direct current (DC), a pulsed current, an alternating current (AC), and so on. The current can include a symmetrical current, an asymmetrical current, etc. The applied current can modulate the light emitted by the VCSEL. In a usage example, modulating is based on asymmetric current injection. An injected asymmetrical current can include a current that is unbalanced or unequal with respect to distribution and/or direction. In a usage example, the current is asymmetrical about the x-axis, that is, the asymmetrical current has a DC offset. The injection of the asymmetrical current can cause the modulated light emitted by the VCSEL to include a polarization. Changing the injected asymmetrical current can change the polarization of the emitted light. The VCSEL can include a ferroelectric liquid crystal layer (FLC). The FLC can include liquid crystals that can be oriented by an electric field. Applying a voltage to the FLC can influence the polarization of light emitted by the VCSEL. In a usage example, a VCSEL with an FLC can include a bottom DBR, and a middle DBR with the FLC layer on top of the middle layer. A top DBR can be included on top of the FLC layer. Other layouts are possible.

Electrical current can be applied to a top p-contact. The p-contact can include a single contact, a ring contact, a “broken ring” contact where the ring is broken into two or more segments, and so on. The p-contact can include one or more p-contacts such as p-contact 350 and p-contact 352. The electrical current can exit the bottom of the VCSEL via one or more n-contacts. The n-contacts can include a single contact, a ring contact, a broken ring contact, etc. The one or more n-contacts include n-contact 360 and n-contact 362. In a usage example, a p-contact ring and an n-contact ring can be concentric broken rings. By accessing a portion of the p-contact ring and the opposite (e.g., diagonally opposite) n-contact ring, a first polarization can be achieved. By accessing the previously unused portion of the p-contact and the previously unused portion of the n-contact, a second polarization can be achieved. In these cases, the electrical current can flow from a first p-contact to a second n-contact (e.g., diagonal opposites), from a second p-contact to a first n-contact, and so on. The VCSEL emits light 370. The light from the VCSEL can be emitted at an angle that can be substantially normal to a substrate, chip, PCB, interposer, etc. to which the VCSEL can be coupled. When there is a purpose for the light emitted by the VCSEL to be angled, then an optical device can be used. The purpose for angling the light can include enhancing optical coupling of the degree of freedom modulated beam (DFMB). Embodiments include angling the DFMB that was emitted by the VCSEL, wherein the angling is based on a micro-optical element (MOE). The MOE can include a micro lens, a diffractive optical element, a Fresnel lens, an asymmetric non-focusing optical device, and so on.

An oxide layer, which can serve as an aperture for the VCSEL, can be fabricated using a technique such as selective thermal oxidation. The selective oxidation can be associated with layers that are aluminum-rich within an AlGaAs VCSEL. However, the selective oxidation can cause stresses within and can introduce defects into the VCSEL. The stresses, particularly in the vicinity of the oxide aperture, can cause cracks and defects such as dark line defects (DLDs) within the active region of the VCSEL. Over time, the DLDs can extend and can be distributed within an active region under electrical stress, thereby leading to VCSEL performance degradation and early failure. The stresses can also introduce plastic deformation of the active area. The plastic deformation can cause defects to further propagate. Further, the process used for creating the oxide layer can reduce volumes of aluminum rich layers within the VCSEL and can introduce large stresses around the oxide layer. The volume reduction or shrinkage can be significant, lowering reliability, especially in high power systems. Techniques for fabricating VCSELs that are oxide-free are discussed below.

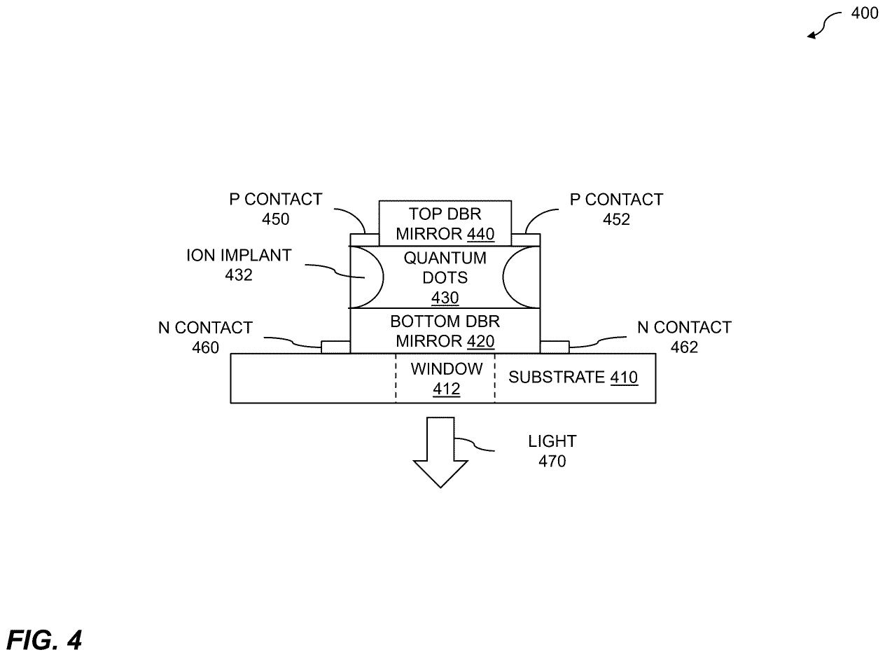

FIG. 4 is an oxide-free quantum dot VCSEL with an ion implant. An ion implant fabrication technique can be used to create a sub-region within an active region of an OQ-VCSEL. The active region associated with the OQ-VCSEL can include at least two sub-regions, where the sub-regions can include a first rate of lasing activity and a second rate of lasing activity. The resulting OQ-VCSEL can be used in place of a VCSEL that included an oxide layer, as discussed previously. Circuits and oxide-free quantum dot vertical-cavity surface-emitting lasers (OQ-VCSELs) are bonded to a photonic wafer-scale interposer (PWSI). The PWSI includes waveguides that can be used to communicate among the circuits, the OQ-VCSELs, and other elements associated with the PWSI. Electrical data is sent by a first circuit to an OQ-VCSEL. A degree of freedom (DoF) of a light beam is modulated. The light beam is emitted by the OQ-VCSEL. The light beam comprises a degree of freedom modulated beam (DFMB) that is based on the electrical data that was sent. The DFMB is coupled to a waveguide. The waveguide is further coupled to an optical decoding element. The optical decoding element decodes the DFMB into the electrical data. The electrical data is delivered to a second circuit.

The block diagram 400 includes a substrate 410. In embodiments, a substrate associated with each OQ-VCSEL within the plurality of OQ-VCSELs can comprise gallium arsenide (GaAs). Other OQ-VCSEL substrate materials may include aluminum-gallium-arsenide (AlGaAs), germanium (Ge), a sapphire substrate, and so on. The substrate can include a thinned substrate. The substrate can be thinned to enable fabrication of an aperture or window 412. The thinning of the substrate can be accomplished by grinding, polishing, etching, and so on. Light in the form of a degree of freedom modulated beam (DFMB) is emitted by the OQ-VCSEL. The light emitted by the VCSEL can exit the VCSEL by passing through the window in the substrate.

The OQ-VCSEL structure comprises an active region or gain medium between two highly reflective mirrors. In some embodiments, each OQ-VCSEL within the plurality of OQ-VCSELs can include one or more quantum dots within an active region, wherein the one or more quantum dots confine a plurality of carriers in three dimensions. The quantum dot structure can limit leakage current and non-non-radiative recombination which can lead to advantageous operating advantages, such as a lower threshold current, than VCSELs with quantum well structures. The first mirror includes a first reflectivity, and the second mirror includes a second reflectivity. In a usage example, the two highly reflective mirrors can be based on Distributed Bragg Reflectors (BDRs). These mirrors can be formed from multiple, alternating layers of materials, where the materials have different refractive indices. The block diagram 400 includes a bottom mirror 420. The bottom mirror can comprise an n-Distributed Bragg Reflector. The bottom mirror can include a reflectivity that is lower than a top mirror (described below). In a usage example, the lower reflectivity of the bottom mirror can include a reflectivity of 93 percent to 99 percent, or another suitable reflectivity. The n-Distributed Bragg Reflectors associated with the bottom mirror can be insulated from other layers in the block diagram.

Recall that an active region can be formed within the OQ-VCSEL. In some embodiments, the forming can include implanting a plurality of ions within the active region. A variety of ions can be used to form the active region. In some embodiments, the implanting can be based on zinc. Other ions that can be used for implantation within the active region of the OQ-VCSEL can include fluorine, oxygen, nitrogen, etc. The active region can enable gain. The block diagram 400 includes an active region comprising quantum dots 430. Light that is emitted by the OQ-VCSEL can be generated within the active region by the quantum dots. The active region can include a semiconductor material. In a usage example, the active region can include quantum dots that can be based on a semiconductor material. The semiconductor material can include gallium arsenide (GaAs), indium-gallium-arsenide (InGaAs), aluminum-gallium-arsenide (AlGaAs), and so on. The active region can be sandwiched between Distributed Bragg Reflectors (DBRs). Recall that the active region of at least one OQ-VCSEL within the plurality of OQ-VCSELs can comprise at least two sub-regions. A first sub-region can include a first rate of lasing activity, and a second sub-region can include a second rate of lasing activity. The at least two sub-regions can be created by various fabrication techniques. The active area can include an ion implant 432. The ion implant can enhance the gain medium by enabling current confinement, optical confinement, and so on. The current confinement and the optical confinement can hold injected carriers and generated photons in close proximity, thereby accomplishing more efficient amplification and radiative recombination. The active region of an OQ-VCSEL can be located within a laser cavity. The block diagram 400 includes a top mirror 440. The top mirror can comprise a p-Distributed Bragg Reflector mirror. The top mirror can include a high reflectivity with respect to the bottom mirror. In a usage example, the reflectivity of the top DBR can include a reflectivity of 99.4 percent to 99.9 percent. Other suitable reflectivities can be implemented.

An electrical current is applied to the VCSEL in order for the VCSEL to lase. The lasing of the VCSEL enables emission of coherent light. The applied electrical current can include a DC current, a pulsed current, an alternating current, and so on. The current can include a symmetrical current, an asymmetrical current, etc. The applied current can modulate the light emitted by the VCSEL. In a usage example, modulating is based on asymmetric current injection. An injected asymmetrical current can include a current that is unbalanced or unequal with respect to distribution and/or direction. The injection of the asymmetrical current can cause the modulated light emitted by the OQ-VCSEL to include a polarization. Changing the injected asymmetrical current can change the polarization of the emitted light. The OQ-VCSEL can include a ferroelectric liquid crystal layer (FLC). The FLC can include liquid crystals that can be oriented by an electric field. Applying a voltage to the FLC can influence the polarization of light emitted by the OQ-VCSEL. In a usage example, an OQ-VCSEL with an FLC can include a bottom DBR, and a middle DBR with the FLC layer on top of the middle layer. A top DBR can be included on top of the FLC layer. Other layouts and configurations are possible.

Electrical current can be applied to a top p-contact. The p-contact can include a single contact, a ring contact, a “broken ring” contact where the ring is broken into two or more segments, and so on. The p-contact can include one or more p-contacts such as p-contact 450 and p-contact 452. The electrical current can exit the bottom of the OQ-VCSEL via one or more n-contacts. The n-contacts can include a single contact, a ring contact, a broken ring contact, etc. The one or more n-contacts can include n-contact 460 and n-contact 462. In a usage example, a p-contact ring and an n-contact ring can be concentric broken rings. By accessing a portion of the p-contact ring and the opposite (e.g., diagonally opposite) n-contact ring, a first polarization can be achieved. The OQ-VCSEL emits light 470. The emitted light can be modulated with a degree of freedom. The modulating the light can result in degrees of freedom that are based on light intensities, light polarizations, transverse electromagnetic (TEM) light modes, light wavelengths, etc. The light from the OQ-VCSEL can be emitted at an angle that can be substantially normal to a substrate, chip, PCB, interposer, etc. to which the OQ-VCSEL can be coupled. When there is a purpose for the light emitted by the OQ-VCSEL to be angled, then an optical device can be used. The purpose for angling the light can include enhancing optical coupling of the degree of freedom modulated beam (DFMB). Embodiments include angling the DFMB that was emitted by the OQ-VCSEL, wherein the angling is based on a micro-optical element (MOE). The MOE can include a micro lens, a diffractive optical element, a Fresnel lens, an asymmetric non-focusing optical device, and so on.

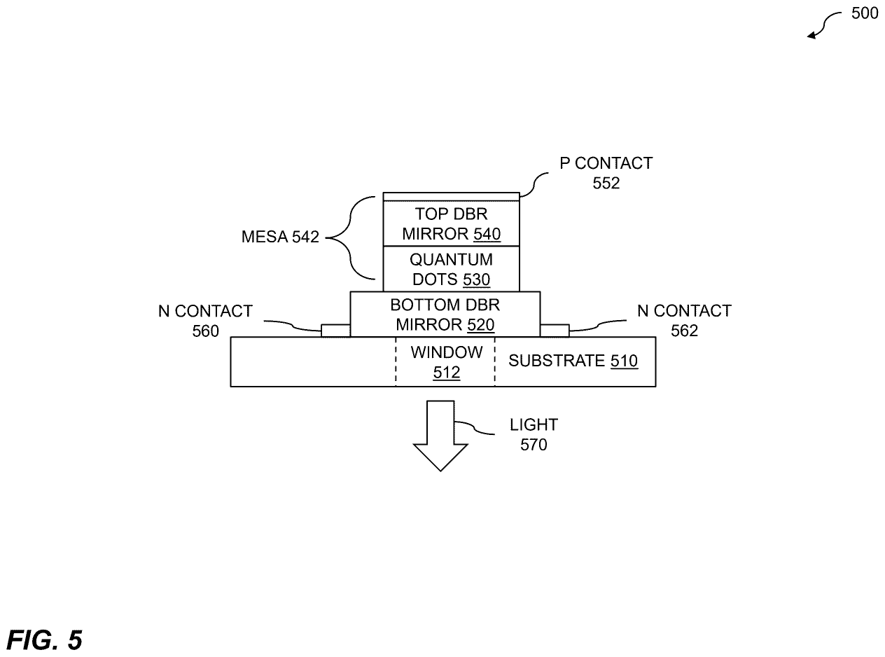

FIG. 5 is an oxide-free VCSEL with a mesa. The oxide-free VCSEL can include an oxide-free quantum-dot VCSEL. A further technique that can be used to form an oxide-free quantum dot VCSEL is based on the formation of a mesa. A mesa can be formed by removing a portion of a semiconductor material on which the OQ-VCSEL is fabricated. The material can be removed using a technique such as etching. The resulting raised area or “mesa” can define an active region where lasing can occur within the OF-VCSEL. The mesa can improve OF-VCSEL performance by controlling current confinement and optical confinement. The active region can be based on quantum dots. The active region associated with the OQ-VCSEL can include at least two sub-regions, where the sub-regions can include a first rate of lasing activity and a second rate of lasing activity.

The block diagram 500 includes a substrate 510. The substrate can include a thinned substrate. The substrate can include a variety of materials suitable to fabricating an OQ-VCSEL. In embodiments, a substrate associated with each OQ-VCSEL within the plurality of OQ-VCSELs can comprise gallium arsenide (GaAs). Other OQ-VCSEL substrate materials may include aluminum-gallium-arsenide (AlGaAs), germanium (Ge), a sapphire substrate, and so on. The substrate can be thinned to enable fabrication of an aperture or window 512. The thinning of the substrate can be accomplished by grinding, polishing, etching, and so on. Light in the form of a degree of freedom-modulated beam (DFMB) is emitted by the OQ-VCSEL. The light emitted by the OQ-VCSEL can exit the OQ-VCSEL by passing through the window in the substrate. The light emitted by the OQ-VCSEL can include a degree of freedom modulated light beam. An OQ-VCSEL can be a semiconductor laser which can be fabricated on a chip. The OQ-VCSEL can comprise an OQ-VCSEL array. The OQ-VCSEL array can include a plurality of OQ-VCSELs.

The active region of the OQ-VCSEL is shown between two highly reflective mirrors. The first mirror includes a first reflectivity, and the second mirror includes a second reflectivity. The first mirror and the second mirror can be various types of mirrors. In a usage example, the two highly reflective mirrors can be based on Distributed Bragg Reflectors (BDRs). The top and bottom mirrors can be formed from multiple, alternating layers of materials, where the materials have different refractive indices. The block diagram 500 includes a bottom mirror 520. The bottom mirror can comprise an n-Distributed Bragg Reflector. The bottom mirror can include a reflectivity that is lower than a top mirror (described below). In a usage example, the lower reflectivity of the bottom mirror can include a reflectivity of 93 percent to 99 percent, or another suitable reflectivity. The n-Distributed Bragg Reflectors associated with the bottom mirror can be insulated from other layers in the block diagram.

Recall that a mesa can be used to define an active region of the OQ-VCSEL. In some embodiments, the forming can include building one or more mesas, wherein the one or more mesas define a current confinement region within the active region of each OQ-VCSEL. The active region can enable gain. The block diagram 500 includes quantum dots 530 within an active region of the OQ-VCSEL. In embodiments, each OQ-VCSEL within the plurality of OQ-VCSELs includes one or more quantum dots within an active region, wherein the one or more quantum dots confine a plurality of carriers in three dimensions. A quantum dot can comprise a semiconductor particle that can exhibit behavior similar to that of an individual atom (e.g., discrete atomic energy levels). Since the confinement can be different from a quantum well VCSEL, an OQ-VCSEL can exhibit better electrical characteristics such as lower threshold current, sharper gain spectrum, better temperature sensitivity, and so on. Quantum dots can be manufactured to emit specific wavelengths of light by modifying various properties of the quantum dots including shape, size, and transparency. In a usage example, a quantum dot can be sized to emit a color of light. The confinement of carriers, whether electrons or holes, can result in unique energy levels such as energy levels in atoms. The confinement can enable a color of light emitted by the quantum dot. Various colors or wavelengths of light can be emitted. In some embodiments, a wavelength of the emitted light beam can be substantially 1.3 μm.

In a usage example, the quantum dots can be based on a semiconductor material such as gallium arsenide (GaAs). Other semiconductor materials that can be used can include indium-gallium-arsenide (InGaAs), aluminum-gallium-arsenide (AlGaAs), and so on. The quantum dots within the active region can be sandwiched between Distributed Bragg Reflectors (DBRs). Recall that the active region of at least one OQ-VCSEL within the plurality of OQ-VCSELs can comprise at least two sub-regions. A first sub-region can include a first rate of lasing activity, and a second sub-region can include a second rate of lasing activity. The at least two sub-regions can be created by various fabrication techniques. The one or more mesas can enhance the active region by enabling current confinement, optical confinement, and so on. The current confinement and the optical confinement can hold injected carriers and generated photons in close proximity, thereby accomplishing more efficient amplification and radiative recombination.

The active region of an OQ-VCSEL can be located within a laser cavity. The block diagram 500 includes a top mirror 540. The top mirror can comprise a p-Distributed Bragg Reflector mirror. The top mirror can include a high reflectivity with respect to the bottom mirror. In a usage example, the reflectivity of the top DBR can include a reflectivity of 99.4 percent to 99.9 percent. Other suitable reflectivities can be implemented. The top DBR can be formed on or within the mesa 542. Recall that the DBR can be formed from alternating layers with varying reflectivities. The alternating layers can comprise layers of AlGaAs with varying aluminum content. The alternating layers can act as a cladding. The cladding can provide a necessary refractive contrast for the Bragg reflection.

An electrical current is applied to the OQ-VCSEL to enable the OQ-VCSEL to lase. The lasing of the OQ-VCSEL enables emission of coherent light. The applied electrical current can include a DC current, a pulsed current, an alternating current, and so on. The current can include a symmetrical current, an asymmetrical current, etc. The applied current can modulate the light emitted by the VCSEL. In a usage example, modulating can be based on asymmetric current injection. An injected asymmetrical current can include a current that is unbalanced or unequal with respect to distribution and/or direction. The injection of the asymmetrical current can cause the modulated light emitted by the OQ-VCSEL to include a polarization. Changing the injected asymmetrical current can change the polarization of the emitted light. The OQ-VCSEL can include a ferroelectric liquid crystal layer (FLC). The FLC can include liquid crystals that can be oriented by an electric field. Applying a voltage to the FLC can influence the polarization of light emitted by the OQ-VCSEL. In a usage example, an OQ-VCSEL with an FLC can include a bottom DBR, and a middle DBR with the FLC layer on top of the middle layer. A top DBR can be included on top of the FLC layer. Other layouts and configurations are possible.

Electrical current can be applied to a top p-contact 552. The p-contact can include a single contact, a ring contact, a “broken ring” contact where the ring is broken into two or more segments, and so on. The example 500 shows a single p-contact on top of the top DBR mirror. Electrical current can be applied to the p-contact. The electrical current can exit the bottom of the OF-VCSEL via one or more n-contacts. The n-contacts can include a single contact, a ring contact, a broken ring contact, etc. In the block diagram 500, the one or more n-contacts include n-contact 560 and n-contact 562. In a usage example, a p-contact ring and an n-contact ring can be concentric broken rings.

The OQ-VCSEL emits light 570. By accessing a portion or all of the p-contact ring and a portion or all of the n-contact ring, various degrees of freedom of light emitted by the OQ-VCSEL can be achieved. The emitted light can be modulated with a degree of freedom. The modulating the light can result in degrees of freedom that are based on light intensities, light polarizations, transverse electromagnetic (TEM) light modes, light wavelengths, etc. The light from the OQ-VCSEL can be emitted at an angle that can be substantially normal to a substrate, chip, PCB, interposer, etc. to which the OQ-VCSEL can be coupled. When there is a purpose for the light emitted by the OQ-VCSEL to be angled, then an optical device can be used. The purpose for angling the light can include enhancing optical coupling of the degree of freedom modulated beam (DFMB). Embodiments include angling the DFMB that was emitted by the OQ-VCSEL, wherein the angling is based on a micro-optical element (MOE). The MOE can include a micro lens, a diffractive optical element, a Fresnel lens, an asymmetric non-focusing optical device, and so on.

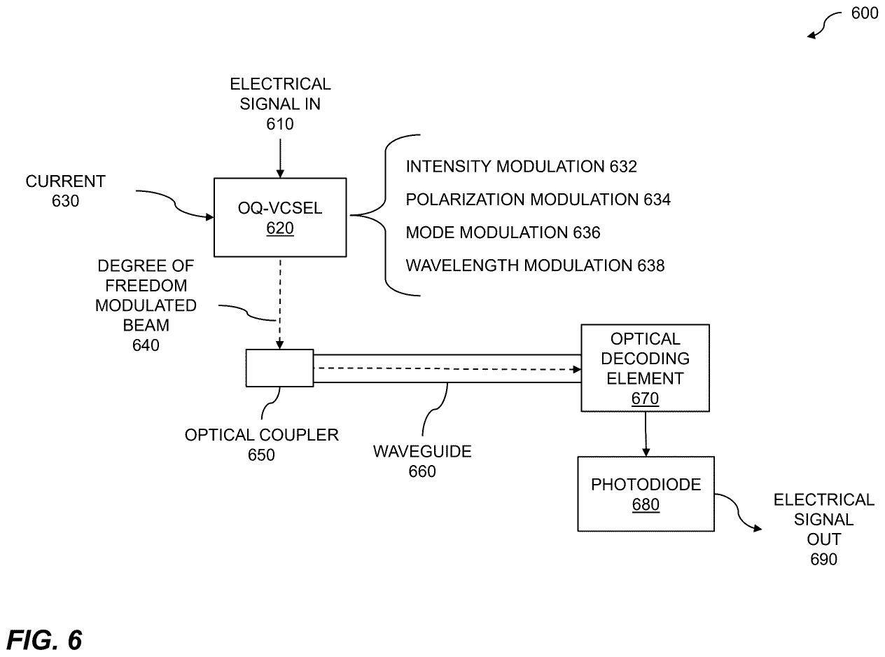

FIG. 6 is a block diagram of an optical link with OQ-VCSEL modulation. An optical link with OQ-VCSEL degree of freedom modulation enables sending electrical data between a first circuit and a second circuit. Circuits and oxide-free quantum dot vertical-cavity surface-emitting lasers (OQ-VCSELs) are bonded to a front side of a photonic wafer-scale interposer (PWSI). The PWSI further includes waveguides. A first circuit, which can be a first chiplet, sends electrical data to an OQ-VCSEL. A degree of freedom (DoF) of a light beam emitted by the OQ-VCSEL is modulated. The modulated emitted light comprises a degree of freedom modulated beam (DFMB). The DFMB is based on the electrical data that was sent. The DFMB is coupled optically to a waveguide. The coupling optically can be accomplished using a mirror, a bent waveguide, an off-axis diffractive lens, a grating coupler, and so on. The waveguide is further coupled to an optical decoding element (ODE). The ODE decodes the DFMB into the electrical data. The electrical data that was decoded is delivered to a second circuit, which can be a second chiplet.

The block diagram 600 includes an electrical signal in 610. The electrical signal can represent data such as image data, video data, and audio data; artificial intelligence (AI) weights, biases, and data; natural language data; and so on. The electrical signal can represent parallel data such as a data set represented as bytes, words, double words, etc. The electrical data can represent serial data. The electrical signal is provided to an oxide-free quantum dot VCSEL (OQ-VCSEL) 620. A light beam emitted by the VCSEL can be modulated. The modulating of the light beam is based on degree of freedom (DoF) modulation. The degree of freedom can include an intensity, a polarization, a mode, a wavelength, etc. The emitted light beam comprises a degree of freedom modulated beam (DFMB). The DFMB can be based on the electrical data. The electrical can be sent by a first circuit to an OQ-VCSEL.

The block diagram 600 includes current 630. The current can include asymmetric current injection, adjusted current, and so on. The current injection can comprise the basis for modulating a degree of freedom of an oxide-free quantum dot vertical-cavity surface-emitting laser (VCSEL). In some embodiments, the degree of freedom comprises an intensity of the OQ-VCSEL 632. The current can be used modulate the intensity of the light emitted by the OQ-VCSEL. The intensity of the light can be varied once sufficient current has been applied to enable the VCSEL to lase. In a usage example, a first amount of current produces a first light intensity that can represent a logic zero, and a second amount of current produces a second light intensity that can represent a logic one. The first amount of injected current can be zero.

In other embodiments, the degree of freedom comprises a polarization of the OQ-VCSEL 634. In a usage example, the light emitted by the OQ-VCSEL can include an s-polarization, which includes polarization that is normal or perpendicular to a surface of incidence, or a p-polarization, which includes polarization that is parallel to a surface of incidence. In some embodiments, the degree of freedom comprises a mode of the OQ-VCSEL 636. A mode can include a transverse electromagnetic (TEM) mode. In a usage example, the TEM modes can include TEM₀₀, TEM₁₀, and TEM₀₁. The TEM₀₀ mode can comprise a fundamental mode, while the TEM₁₀ mode and the TEM₀₁ mode can comprise higher order modes. In some embodiments, the degree of freedom comprises a wavelength of the OQ-VCSEL 638. In a usage example, the wavelength modulation can be based on a VCSEL chirp.

The degree of freedom modulating includes emitting a light beam by the OQ-VCSEL. The emitted light comprises a degree of freedom modulated beam (DFMB) 640. The DFMB is based on the electrical data that was sent. The DFMB can be directed toward an optical coupler 650. The optical coupler can include a coupler on or within a circuit board, a wafer, an interposer, etc. In a usage example, the optical coupler can be on or within the PWSI. The optical coupler couples optically the DFMB to an optical medium. The optical medium can comprise a waveguide. The waveguide can be a waveguide within the plurality of waveguides included in the PWSI. The optical medium can comprise a fiber, a multicore fiber, and so on. The fiber can connect to circuits, chips, switches, accelerators, memory devices, etc. external to the PWSI. The optical coupler can be based on a variety of optical elements, techniques, and so on.

In some embodiments, the coupling optically is based on a grating coupler. The grating coupler can diffract light at specific frequencies, input angles, etc. thereby providing efficient transfer of light at a specific frequency into or out of a waveguide. To aid the coupling to a grating coupler, the DFMB emitted from the OQ-VCSEL can be angled. Embodiments include angling the PMB that was emitted by the OQ-VCSEL, wherein the angling is based on a micro-optical element (MOE). The MOE can be based on one or more optical techniques including a micro lens, a Fresnel lens, an asymmetric non-focusing optical device, and so on. In other embodiments, the coupling optically is based on a mirror. The mirror can include a mirror within a circuit, a chip, a wafer, an interposer, and so on. In a usage example, the coupling is based on a crystallographic etched mirror. A mirror, such as a crystallographic etched mirror, can operate in combination with an MOE, such as described above, which can be placed over or near an aperture of the OQ-VCSEL. For example, the MOE can pre-angle light from the OQ-VCSEL so that when the light is reflected by the TMAH mirror, it is efficiently coupled directly into the waveguide at 90 degrees, or sufficiently close to 90 degrees, from the light source. In other embodiments, the coupling optically is based on a bent waveguide. The bent waveguide can include a high containment region of a waveguide. The high containment waveguide can redirect the light while minimizing loss of light in the region of the bend of the waveguide. In some embodiments, the coupling optically is based on an off-axis diffractive lens. An off-axis diffractive lens can direct light at an angle with respect to the optical axis of the lens. An off-axis diffractive lens can direct the DFMB at an angle substantially normal to an input aperture of the waveguide into the waveguide.

The block diagram 600 includes a waveguide 660. The waveguide can include an optical medium that is capable of transferring the DFMB coupled to the waveguide by the optical coupler. The waveguide can include a waveguide on or within a wafer, an interposer such as the PWSI, and so on. As described above, the waveguide can be replaced by an optical fiber, a multicore fiber, and so on. The block diagram 600 includes an optical decoding element (ODE) 670 to which the waveguide is further coupled. The ODE can be based on a variety of optical elements, optical techniques, and so on. The ODE can separate different degrees of freedom of light from the DFMB. The separated degrees of freedom of light (e.g., optical data) can be decoded into electrical data that was sent via the electrical signal input. The ODE can accomplish decoding the DFMB based on a variety of decoding techniques. The ODE can comprise a grating coupler. The grating coupler can separate different degrees of freedom of light from each other. In a usage example, the separated degrees of freedom of light can be sent to optical receivers, where the optical receivers can convert the optical data to electrical data. In another usage example, the grating coupler can indicate when a first degree of freedom is active in the optical medium, which can comprise a logic “1.” The absence of the signal from the grating coupler can comprise a logic “0.” Clocking, such as clock and data recovery (CDR) circuits, can synchronize the DFMB with the receiving and/or decoding circuits. The optical decoding element can comprise a polarization filter. The polarization filter can enable a first polarization of light to pass through the polarization filter while a second polarization of light is substantially reflected by the polarization filter. The optical decoding element can comprise a polarization multiplexor (PMUX). The multiplexer can combine different polarizations when the DFMB is coupled optically to the waveguide, and the multiplexer can separate the different polarizations of the DFMB at the far end of the waveguide.

Some usage examples can include transforming each optical signal within at least two optical degrees of freedom signals, by a unique photodiode, to an electrical signal. The transforming each optical signal can result in at least two electrical signals. The block diagram 600 includes a photodiode 680. More than one photodiode can be included, where each photodiode can transform or decode an optical signal into an electrical signal. The ODE decodes the DFMB into the electrical data that was sent. The decoded DFMB is sent as an electrical signal out 690. The at least two electrical signals can be assembled into a single electrical signal, where the single electrical signal comprises the electrical data that was sent. The single electrical signal that includes the electrical data that was sent can be delivered to a destination element such as a second circuit. The destination element can include a processor, an AI accelerator chiplet, a switching chiplet, a disaggregated memory, etc.

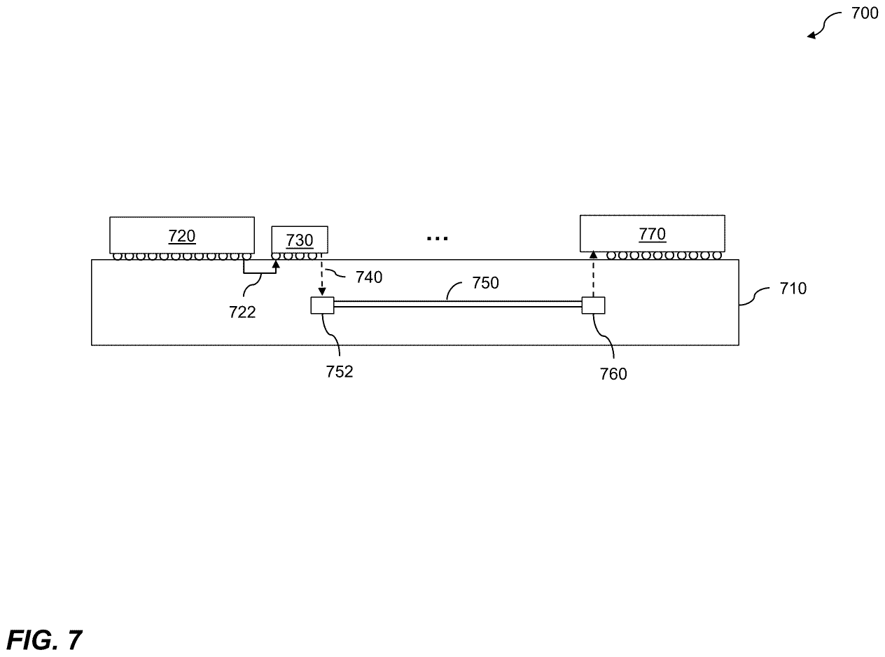

FIG. 7 is an apparatus for optical links on a directly modulated photonic wafer-scale interposer with oxide-free VCSELs. The optical links are used for transmitting data between circuits, chiplets, cores, ASICs, memories, and so on. An optical link can include a waveguide within a photonic wafer-scale interposer (PWSI). The optical link can be established to enable transmitting data between circuits bonded to the PWSI. The circuits can include AI accelerator circuits, switching circuits, and so on. The optical link can be used to send data from a first circuit to a second circuit. The first circuit and the second circuit can comprise a first chiplet and a second chiplet, respectively. The circuits can be co-located on a circuit board, wafer, or interposer such as a photonic wafer-scale interposer (PWSI); located in different multiprocessors; located in different datacenters; and so on. Circuits and oxide-free quantum dot vertical-cavity surface-emitting lasers (OQ-VCSELs) are bonded to a photonic wafer-scale interposer (PWSI). The PWSI includes waveguides that can be used for transmitting data. A first circuit sends electrical data to an OQ-VCSEL. A light beam emitted by the OQ-VCSEL is modulated. The modulated emitted light beam comprises a degree of freedom modulated beam (DFMB) that is based on the electrical data that was sent by the first circuit. The DFMB is coupled optically to a waveguide. The waveguide is further coupled to an optical decoding element (ODE). The ODE decodes the DFMB into the electrical data. The electrical data is delivered to a second circuit. The optical link is enabled by optical links on a directly modulated photonic wafer-scale interposer with oxide-free VCSELs.

An apparatus is disclosed for transmitting data comprising: a directly modulated photonic wafer-scale interposer (PWSI), wherein the PWSI includes a plurality of waveguides, and wherein a plurality of circuits and a plurality of oxide-free quantum dot vertical-cavity surface-emitting lasers (OQ-VCSELs) are bonded to a front side of the PWSI; a first circuit within the plurality of circuits, wherein the first circuit is coupled to an OQ-VCSEL within the plurality of OQ-VCSELs, wherein the first circuit sends electrical data to the OQ-VCSEL, and wherein the OQ-VCSEL, when modulated, emits a degree of freedom modulated beam (DFMB); an optical coupler, wherein the optical coupler couples optically the DFMB to a first waveguide within the plurality of waveguides; an optical decoding element, wherein the optical decoding element is further coupled to the first waveguide, and wherein the optical decoding element decodes the DFMB into the electrical data that was sent; and a second circuit within the plurality of circuits, wherein the second circuit receives the electrical data that was decoded.

The apparatus 700 includes a directly modulated photonic wafer-scale interposer (PWSI) 710, wherein the PWSI includes a plurality of waveguides, and wherein a plurality of circuits and a plurality of oxide-free quantum dot vertical-cavity surface-emitting laser (OQ-VCSELs) are bonded to a front side of the PWSI. The PWSI can comprise a wafer, where the wafer includes a material suitable for fabricating the PWSI. In a usage example, the PWSI comprises silicon wafer or a glass wafer. The PWSI can include a plurality of waveguides. The plurality of waveguides can be used to enable communication between circuits, chiplets, cores, cores on a wafer, SOCs, processors, AI accelerators, switches, and so on. The plurality of waveguides can enable communication between circuits and surface-emitting light sources such as the OQ-VCSELs. Other surface-emitting light sources that can be modulated can include light emitting diodes (LEDs), laser diodes, etc. The PWSI can include a plurality of circuits, and a plurality of oxide-free quantum dot vertical-cavity surface-emitting laser (OQ-VCSELs), that are bonded to a front side of the PWSI. The bonding the plurality of circuits and the plurality of OQ-VCSELs can include coupling the circuits and the OQ-VCSELs to interconnect, metal layers, and so on associated with the PWSI.

The apparatus 700 includes a first circuit 720 within the plurality of circuits, wherein the first circuit is coupled to an OQ-VCSEL within the plurality of OQ-VCSELs, wherein the first circuit sends electrical data to the OQ-VCSEL, and wherein the OQ-VCSEL, when modulated, emits a degree of freedom modulated beam (DFMB). Noted previously and throughout, the plurality of circuits can include one or more of chips, chiplets, cores, cores on a wafer, SOCs, processors, AI accelerators, switches, and so on. The first circuit is coupled to an OQ-VCSEL 730. The OQ-VCSEL can comprise a single VCSEL, an array of VCSELs, etc. The VCSELs can comprise a material suitable for fabricating the VCSELs. The suitable material can include gallium arsenide. The first circuit sends electrical data 722 to the OQ-VCSEL. The sending can be accomplished using interconnect, metal layers, and so on associated with the PWSI. In a usage example, the metal layers can enable high speed communication between the first circuit and the OQ-VCSEL because the interconnections enabled by the metal layers are short. The short interconnects reduce parasitics and thus propagation delays. The OQ-VCSEL can be modulated. The OQ-VCSEL, when modulated, emits a degree of freedom modulated beam (DFMB) 740. The DFMB can include one or more degrees of freedom such as light intensities, light polarizations, light modes such as TEM modes, light wavelengths, etc. The DFMB enables transmitting data by using the OQ-VCSEL to convert electrical data to optical (e.g., light based) data.

The apparatus 700 includes an optical coupler 752, wherein the optical coupler couples optically the DFMB to a first waveguide 750 within the plurality of waveguides. The optical coupler can couple optically the emitted light beam to other optical media. The other optical media can include an optical fiber. In a usage example, the optical medium can comprise a degree of freedom maintaining fiber. Various optical elements can be used as an optical coupler to optically couple a degree of freedom modulated beam (DFMB) to the optical element. The coupling optically can be accomplished using the optical coupler. The optical coupler can comprise a mirror. In a usage example, the mirror can include a nano-imprint lithography mirror. The optical coupler can comprise a grating coupler. The grating coupler can include a periodic grating that can transfer the DFMB with low loss into the optical medium. Embodiments can include angling the DFMB that was emitted by the OQ-VCSEL, wherein the angling is based on a micro-optical element (MOE). The angling the DFMB can be used to complement an angle associated with the coupling the DFMB to the optical medium.

The apparatus 700 includes an optical decoding element (ODE) 760, wherein the optical decoding element is further coupled to the first waveguide, and wherein the optical decoding element decodes the DFMB into the electrical data that was sent. The ODE can distinguish among different degrees of freedom of light within the DFMB emitted by the OQ-VCSEL. The ODE can separate different degrees of freedom including intensities of light, polarizations of light, modes of light, wavelengths of light, etc. The separated degrees of freedom of light can be decoded into electrical data that was sent by the first circuit. The ODE can accomplish decoding based on a plurality of decoding techniques. In some embodiments, the ODE can comprise a grating coupler. The grating coupler separates different light intensities, polarizations, modes, and wavelengths in the DFMB from each other. The separated degrees of freedom of light can be sent to optical receivers that convert the optical data to electrical data. In a usage example, an optical receiver can comprise a photodiode. In another usage example, the PDOE can comprise a polarization filter. A polarization filter can enable passage of light with a polarization that is compatible with the polarization filter while substantially filtering out light with polarizations that are incompatible with the polarization filter. In a further usage example, the PDOE can comprise a polarization multiplexor (PMUX). The PMUX can separate light that includes two or more polarizations. In a usage example, the received light is separated into two or more beams where each beam is based on a single polarization. In a usage example, a beam splitter can reflect light associated with a first polarization and transmit light associated with a second polarization.

The apparatus 700 includes a second circuit 770 within the plurality of circuits, wherein the second circuit receives the electrical data that was decoded. The second circuit can receive transmitted data that was sent by the first circuit. The first circuit and the second circuit can be located on a different or a common circuit board, a different or a common wafer, a different or a common rack, and so on. The first circuit and the second circuit can be remotely located with respect to each other. “Remotely located” can include locating the first circuit and the second circuit in separate circuit boards or wafers, separate multiprocessors, separate data racks, separate data centers, and so on. The first circuit, the second circuit, and the OQ-VCSEL can be coupled to a circuit board, included within a chip, etc. Recall that in some embodiments, the plurality of circuits includes a plurality of chiplets, and the first circuit and the second circuit comprise a first chiplet within the plurality of chiplets and a second chiplet within the plurality of chiplets, respectively. In a usage example, the first chiplet, the second chiplet, and the OQ-VCSEL are within a plurality of chiplets bonded to a front side of a photonic wafer-scale interposer (PWSI). The PWSI can further include a plurality of waveguides and a plurality of through-silicon vias (TSVs). The optical medium can include a waveguide within the plurality of waveguides.

Discussed previously, the plurality of circuits can comprise chiplets. In some embodiments, the plurality of circuits includes a plurality of chiplets, and wherein the first circuit and the second circuit comprise a first chiplet within the plurality of chiplets and a second chiplet within the plurality of chiplets, respectively. The chiplets can be bonded to the PWSI. The PWSI can enable high-speed communication between and among chiplets and OQ-VCSELs coupled to the PWSI. The PWSI can be configured to accomplish a variety of processing tasks. In some embodiments, the PWSI comprises an optical wafer-scale AI accelerator, wherein one or more chiplets within the plurality of chiplets comprise one or more artificial intelligence (AI) accelerators. The AI accelerators can be used for training AI models and machine learning (ML) models, executing the AI models and the ML models, and the like. The AI models and ML models can be applied to processing applications such as video and image processing, audio processing and voice recognition, etc. In other embodiments, the PWSI comprises an optical wafer-scale network switch, wherein one or more chiplets within the plurality of chiplets comprise one or more switching chiplets. The optical wafer-scale network switch can be used for accessing and transferring large amounts of data such as data associated with training AI models and ML models. The optical wafer-scale network switch can transfer data to be processed by the trained models.

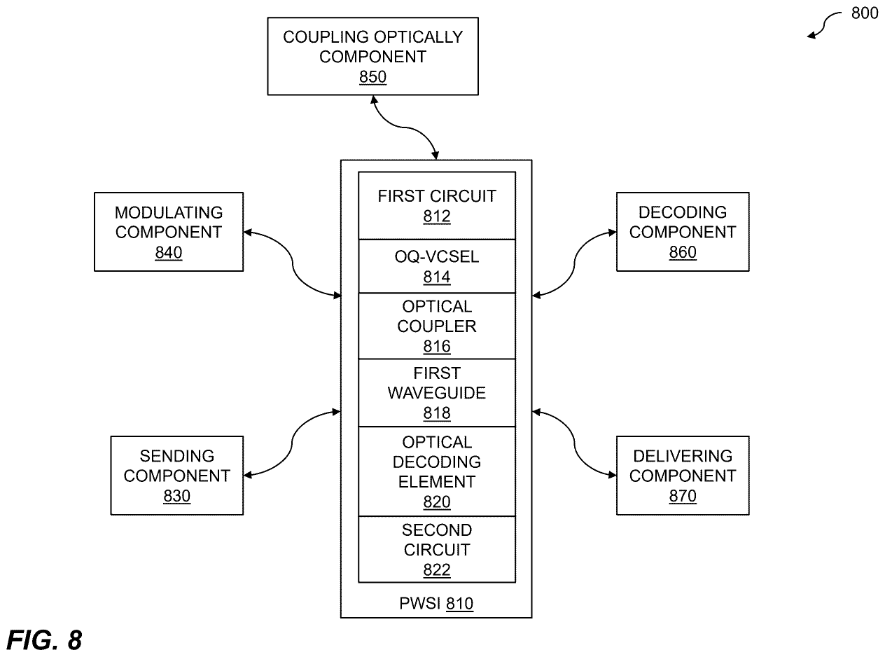

FIG. 8 is a system diagram for optical links with oxide-free quantum dot VCSELs on a directly modulated photonic wafer-scale interposer. Circuits and oxide-free quantum dot vertical-cavity surface-emitting lasers (OQ-VCSELs) are bonded to a front side of a photonic wafer-scale interposer (PWSI). The PWSI includes waveguides. Electrical data, which can include serial data, is sent from a first circuit to an OQ-VCSEL. A degree of freedom (DoF) of a light beam can be modulated. The modulated light beam can be emitted by the first OQ-VCSEL. The emitted light beam comprises a degree of freedom modulated beam (DFMB). The DFMB can be based on the electrical data that was sent. The degree of freedom modulation can include an intensity of light, a polarization of light, a light mode, and a light wavelength. The DFMB is based on the electrical data that was sent. The DFMB can be coupled optically to waveguide or other optical medium such as an optical fiber. The coupling optically can be accomplished using a mirror, a bent waveguide, an off-axis diffractive lens, a grating coupler. The waveguide can be further coupled to an optical decoding element (ODE). The ODE decodes the DFMB into electrical data. The electrical data that was decoded can be delivered to a second circuit. The circuits can include chiplets. The first circuit and the second circuit can include a first chiplet and a second chiplet, respectively.

Disclosed is a system for transmitting data comprising: a directly modulated photonic wafer-scale interposer (PWSI), wherein the PWSI includes a plurality of waveguides, and wherein a plurality of circuits and a plurality of oxide-free quantum dot vertical-cavity surface-emitting lasers (OQ-VCSELs) are bonded to a front side of the PWSI; a first circuit within the plurality of circuits, wherein the first circuit is coupled to an OQ-VCSEL within the plurality of OQ-VCSELs; an optical coupler, wherein the optical coupler couples optically a light beam emitted from the OQ-VCSEL to a first waveguide within the plurality of waveguides; an optical decoding element, wherein the optical decoding element is further coupled to the first waveguide; and a second circuit within the plurality of circuits; wherein the system is configured to: send electrical data, by the first circuit to the OQ-VCSEL; modulate a property of the OQ-VCSEL, wherein modulating includes emitting, by the OQ-VCSEL, a degree of freedom modulated beam (DFMB), wherein the DFMB is based on the electrical data that was sent; couple optically, by the optical coupler, the DFMB to the first waveguide; decode, by the optical decoding element, the DFMB into the electrical data; and deliver the electrical data that was decoded to the second circuit.

The system 800 includes a directly modulated photonic wafer-scale interposer (PWSI) 810, wherein the PWSI includes a plurality of waveguides, and wherein a plurality of circuits and a plurality of oxide-free quantum dot vertical-cavity surface-emitting lasers (OQ-VCSELs) are bonded to a front side of the PWSI. The PWSI can comprise a wafer such as a silicon wafer, a glass wafer, and so on. The PWSI can include a front side and back side. Circuits and other various electronic, optical, electrooptical, and other elements can be bonded to the front side of the PWSI. The PWSI can include interconnect, metal layers, and so on that can be used to provide connectivity between and among elements by coupling the bonded elements to the interconnect, metal layers, etc. The plurality of waveguides can be used to communicate between elements such as circuits, chiplets, cores, etc. bonded to the PWSI. In embodiments, the plurality of circuits includes a plurality of chiplets, and the first circuit and the second circuit comprise a first chiplet within the plurality of chiplets and a second chiplet within the plurality of chiplets, respectively.

The system 800 includes a first circuit 812 within the plurality of circuits, wherein the first circuit is coupled to an OQ-VCSEL within the plurality of OQ-VCSELs 814. The first circuit can include a chiplet within a plurality of chiplets. The chiplets can include processor chiplets, memory chiplets, AI accelerator chiplets, switching chiplets, I/O chiplets, and the like. Surface-emitting light sources, other than an OQ-VCSEL, can also be used. The other surface-emitting light sources can also be modulated. In a usage example, a surface-emitting light source can include a light emitting diode (LED), a laser diode, and so on.

The system 800 includes an optical coupler 816, wherein the optical coupler couples optically a light beam emitted from the OQ-VCSEL to a first waveguide 818 within the plurality of waveguides. The optical coupler can couple optically the emitted light beam to other optical media. The other optical media can include an optical fiber, an optical bundle, and so on. In a usage example, the optical medium can comprise a degree of freedom maintaining fiber. Various optical elements can be used as an optical coupler to optically couple a degree of freedom modulated beam (DFMB) to the optical element. The coupling optically can be accomplished using the optical coupler. As described throughout, the optical coupler can comprise a mirror, a bent waveguide, an off-axis diffractive lens, a grating coupler, and so on. Any of these methods can be used alone or in combination to accomplish the coupling of the light beam emitted from the OQ-VCSEL to the first waveguide. Some embodiments include angling the DFMB that was emitted by the OQ-VCSEL, wherein the angling is based on a micro-optical element (MOE). The angling the PFMB can be used to complement an angle associated with the coupling the DFMB to the optical medium.

The system 800 includes an optical decoding element (ODE) 820, wherein the optical decoding element is further coupled to the first waveguide. The optical decoding element decodes the DFMB into the electrical data that was sent. The ODE can distinguish among different degrees of freedom of light within the DFMB emitted by the OQ-VCSEL. The ODE can separate different degrees of freedom including intensities of light, polarizations of light, modes of light, wavelengths of light, etc. The separated degrees of freedom of light can be decoded into electrical data that was sent by the first circuit. The ODE can accomplish decoding based on a plurality of decoding techniques. In a usage example, the ODE can comprise a grating coupler. The grating coupler separates different polarizations, modes, and wavelengths in the DFMB from each other. The separated degrees of freedom of light can be sent to optical receivers that convert the optical data to electrical data. In a usage example an optical receiver can comprise a photodiode. In another usage example, the PDOE comprises a polarization filter. A polarization filter can enable passage of light with a polarization that is compatible with the polarization filter, while substantially filtering out light with polarizations that are incompatible with the polarization filter. In a further usage example, the PDOE can comprise a polarization multiplexor (PMUX). The PMUX can separate light that includes two or more polarizations. In a usage example, the received light can be separated into two or more beams, where each beam is based on a single polarization. In another usage example, a beam splitter can reflect light associated with a first polarization and transmit light associated with a second polarization.

The system 800 includes a second circuit 822. The second circuit can be a circuit within the plurality of circuits. The second circuit can be a circuit substantially similar to or different from the first circuit. The first circuit and the second circuit can comprise separate cores, cores on a wafer, chiplets, SoCs, wafers, interposers, ASICs, and so on. The first circuit and the second circuit can comprise circuits within the same chip or different chips, chiplets, SoCs, wafers, interposers, etc. The first circuit and the second circuit can comprise processors, multi-core processors, memory controllers, memory chips such as DDR or HBM chips, I/O chips, AI accelerators, switching chips, cores, cores on or within a wafer, and so on. In embodiments, the plurality of circuits includes a plurality of chiplets, and wherein the first circuit and the second circuit comprise a first chiplet within the plurality of chiplets and a second chiplet within the plurality of chiplets, respectively. In a usage example, the first chiplet and the second chiplet comprise artificial intelligence (AI) accelerators. In a second usage example, the first chiplet and the second chiplet comprise switching chiplets. The second chiplet can be substantially different in function, type of chip, pin layout, etc. from the first chiplet. The second chiplet can be co-located within a plurality of chiplets that also includes the first chiplet. The second chiplet can be located remotely from the first chiplet.

The system 800 includes a sending component 830. The sending component is configured to send electrical data, by the first circuit, to the OQ-VCSEL. The data can be sent by the first circuit to the OQ-VCSEL using one or more of wires, interconnect, metal layers, etc. The metal layers can include metal layers within a circuit board, a wafer, an interposer, and so on. The metal layers, which enable interconnection between and among circuits, chiplets, and other elements, can be fabricated on or within a circuit board, wafer, or interposer such as the PWSI, etc. Using the metal layers can offer significant communication speed due to short wire lengths, and reduced “parasitics” such as resistance, capacitance, and inductance. The OQ-VCSEL can emit light based on the sent data. The emitted light represents the data as optical data. The emitted light can be modulated, where the modulated light can represent electrical data that was sent.

The system 800 includes a modulating component 840. The modulating component is configured modulate a property of the OQ-VCSEL, wherein the modulating includes emitting, by the OQ-VCSEL, a degree of freedom modulated beam (DFMB), wherein the DFMB is based on the electrical data that was sent. As described throughout, the DFMB can include a beam with a plurality of degrees of freedom such as intensities, polarizations, modes, and wavelengths. In a usage example, the DFMB can include two degrees of freedom, where one degree of freedom represents a logic one and the second degree of freedom represents a logic zero. In another usage example, two degrees of freedom can represent two different serial data streams. The first circuit can send data to other surface-emitting light sources that can be modulated, such as light emitting diodes (LEDs), laser diodes (LDs), and the like. The DFMB can include a high intensity and/or a low intensity. The DFMB can include an s-polarization. For s-polarization, the electric field of the modulated light is normal to a surface of incidence. The DFMB can include p-polarization. For p-polarization, the electric field of the modulated light is parallel to the surface of incidence. The DFMB can include a mode. A mode can include a transverse electromagnetic (TEM) mode. In a usage example, the TEM modes can include TEM₀₀, TEM₁₀, and TEM₀₁. The DFMB can include a wavelength. The wavelength can be based on a VCSEL chirp.

The system 800 includes a coupling optically component 850. The coupling optically component is configured to couple optically, by the optical coupler, the DFMB to the first waveguide. The coupling optically can be used to couple the DFMB to other optical media such as an optic fiber. An optical medium can include a low loss optical medium appropriate for sending the DFMB. In a usage example, the optical medium can comprise a degree of freedom maintaining fiber. The coupling optically is accomplished using the optical coupler. A variety of optical couplers can be used, as described above. The optical coupler can include a mirror, a bent waveguide, an off-axis diffractive lens, a grating coupler, and so on.

The system 800 includes a decoding component 860. The decoding component is configured to decode, by the optical decoding element, the DFMB into the electrical data. The optical decoding element (ODE) can separate distinct degrees of freedom of light from the DFMB. One or more degrees of freedom can be based on light intensities, polarizations of light, modes of light, light wavelengths, and so on. The DoF intensities can include a high intensity and a low intensity. The polarizations can be based on an s-polarization, a p-polarization, and so on. The modes can be based on the TEM modes, where the TEM modes can include TEM₀₀, TEM₁₀, and TEM₀₁, and so on. The wavelengths can be based on an OQ-VCSEL chirp. In a usage example, the OQ-VCSEL can include a ferroelectric liquid crystal layer (FLC). By adjusting carrier density by injecting current, an OQ-VCSEL emitted beam wavelength can be adjusted. The separated degrees of freedom of light, which are based on optical data, can be decoded into electrical data. The decoded electrical data is the data that was sent by the first circuit. As described above and throughout, the ODE can accomplish decoding based on a plurality of decoding techniques, such as a grating coupler, a polarization filter, a polarization mux, and so on.

The system 800 includes a delivering component 870. The delivering component is configured to deliver the electrical data that was decoded to the second circuit. The decoded electrical data can be delivered by the delivering component to the second circuit using wire, interconnect, metal layers, fiberoptic cable, and so on. The metal layers can include metal layers within a circuit board, a wafer, an interposer, the PWSI, and so on. The metal layers, which enable interconnection between and among circuits, chiplets and other elements, can be fabricated on or within a board, wafer, interposer, etc. As was the case for sending the data from the first circuit to an OQ-VCSEL, using the metal layers can offer significant communication speed due to short wire lengths, and reduced “parasitics” such as resistance, capacitance, and inductance. The second circuit can process the delivered data, forward the delivered data, etc.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A method for transmitting data comprising:
bonding, to a front side of a directly modulated photonic wafer-scale interposer (PWSI), a plurality of circuits and a plurality of oxide-free quantum dot vertical-cavity surface-emitting lasers (OQ-VCSELs), wherein the PWSI includes a plurality of waveguides;
sending electrical data, by a first circuit within the plurality of circuits, to an OQ-VCSEL within the plurality of OQ-VCSELs;
modulating a degree of freedom (DoF) of a light beam emitted by the OQ-VCSEL, wherein the emitted light beam comprises a degree of freedom modulated beam (DFMB), wherein the DFMB is based on the electrical data that was sent;
coupling optically the DFMB to a waveguide within the plurality of waveguides, wherein the waveguide is further coupled to an optical decoding element;
decoding, by the optical decoding element, the DFMB into the electrical data; and
delivering the electrical data that was decoded to a second circuit within the plurality of circuits.

2. The method of claim 1 wherein each OQ-VCSEL within the plurality of OQ-VCSELs includes one or more quantum dots within an active region, wherein the one or more quantum dots confine a plurality of carriers in three dimensions.

3. The method of claim 2 wherein a substrate associated with each OQ-VCSEL within the plurality of OQ-VCSELs comprises gallium arsenide (GaAs).

4. The method of claim 3 wherein a wavelength of the emitted light beam is substantially 1.3 μm.

5. The method of claim 1 further comprising forming an active region within the OQ-VCSEL.

6. The method of claim 5 wherein the active region of at least one OQ-VCSEL within the plurality of OQ-VCSELs comprises at least two sub-regions, wherein a first sub-region within the at least two sub-regions includes a first rate of lasing activity, and wherein a second sub-region within the at least two sub-regions includes a second rate of lasing activity.

7. The method of claim 5 wherein the forming includes implanting a plurality of ions within the active region.

8. The method of claim 7 wherein the implanting is based on zinc.

9. The method of claim 5 wherein the forming includes depositing, within the active region, an out-of-phase gain medium.

10. The method of claim 5 wherein the forming includes lithographic patterning.

11. The method of claim 5 wherein the forming is based on one or more buried tunnel junctions (BTJs).

12. The method of claim 5 wherein the forming includes one or more sub-wavelength gratings.

13. The method of claim 5 wherein the forming includes one or more photonic crystals.

14. The method of claim 5 wherein the forming includes regrowth with an etch stop.

15. The method of claim 5 wherein the forming includes building one or more mesas, wherein the one or more mesas define a current confinement region within the active region of each OQ-VCSEL.

16. The method of claim 5 further comprising fabricating, an aperture within the OQ-VCSEL, separately from the active region.

17. The method of claim 1 wherein the degree of freedom comprises an intensity of the OQ-VCSEL.

18. The method of claim 1 wherein the degree of freedom comprises a polarization of the OQ-VCSEL.

19. The method of claim 1 wherein the degree of freedom comprises a mode of the OQ-VCSEL.

20. The method of claim 1 wherein the degree of freedom comprises a wavelength of the OQ-VCSEL.

21. The method of claim 1 wherein the coupling optically is based on a mirror.

22. The method of claim 1 wherein the coupling optically is based on a bent waveguide.

23. The method of claim 1 wherein the coupling optically is based on an off-axis diffractive lens.

24. The method of claim 1 wherein the coupling optically is based on a grating coupler.

25. The method of claim 24 further comprising angling the DFMB that was emitted by the OQ-VCSEL, wherein the angling is based on a micro-optical element (MOE).

26. An apparatus for transmitting data comprising:
a directly modulated photonic wafer-scale interposer (PWSI), wherein the PWSI includes a plurality of waveguides, and wherein a plurality of circuits and a plurality of oxide-free quantum dot vertical-cavity surface-emitting lasers (OQ-VCSELs) are bonded to a front side of the PWSI;
a first circuit within the plurality of circuits, wherein the first circuit is coupled to an OQ-VCSEL within the plurality of OQ-VCSELs, wherein the first circuit sends electrical data to the OQ-VCSEL, and wherein the OQ-VCSEL, when modulated, emits a degree of freedom modulated beam (DFMB);
an optical coupler, wherein the optical coupler couples optically the DFMB to a first waveguide within the plurality of waveguides;
an optical decoding element, wherein the optical decoding element is further coupled to the first waveguide, and wherein the optical decoding element decodes the DFMB into the electrical data that was sent; and
a second circuit within the plurality of circuits, wherein the second circuit receives the electrical data that was decoded.

27. A system for transmitting data comprising:
a directly modulated photonic wafer-scale interposer (PWSI), wherein the PWSI includes a plurality of waveguides, and wherein a plurality of circuits and a plurality of oxide-free quantum dot vertical-cavity surface-emitting lasers (OQ-VCSELs) are bonded to a front side of the PWSI;
a first circuit within the plurality of circuits, wherein the first circuit is coupled to an OQ-VCSEL within the plurality of OQ-VCSELs;
an optical coupler, wherein the optical coupler couples optically a light beam emitted from the OQ-VCSEL to a first waveguide within the plurality of waveguides;
an optical decoding element, wherein the optical decoding element is further coupled to the first waveguide; and
a second circuit within the plurality of circuits;
wherein the system is configured to:
send electrical data, by the first circuit to the OQ-VCSEL;
modulate a property of the OQ-VCSEL, wherein modulating includes emitting, by the OQ-VCSEL, a degree of freedom modulated beam (DFMB), wherein the DFMB is based on the electrical data that was sent;
couple optically, by the optical coupler the DFMB to the first waveguide;
decode, by the optical decoding element, the DFMB into the electrical data; and
deliver the electrical data that was decoded to the second circuit.
